(19) United States
(12) Patent Application Publication
(10) Pub. No.: US 2003/0163479 A1
(43) Pub. Date: Aug. 28, 2003

(54) Method and apparatus for implementing a data management system using a metadata specification

(76) Inventors: Michael B. Mathews, Kirkland, WA (US); Kevin C. Wonus, Everett, WA (US); Mark J. Seilstad, Kent, WA (US); Li Wang, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/147,362

(22) Filed: May 13, 2002

Related U.S. Application Data
(60) Provisional application No. 60/290,896, filed on May 14, 2001.

(51) Int. Cl. G06F 7/00

(52) U.S. Cl. 707/102

(57) ABSTRACT

The system and method of the present invention provide for a means to create a fully functional object-oriented data access model to one or more data stores. In particular, the framework of the invention can automatically implement any object relationship model describing object attribution, behavior, navigability, and other properties through a distributed client server access model. The framework provides a well-defined client access-model, fully encapsulating the data storage and management using an object-oriented application-programming interface. Additional aspects of the invention provide for integration with object oriented analysis tools, dynamic integration, and security.

### CROSS-REFERENCE(S) TO RELATED APPLICATION(S)

This application claims the benefit of prior U.S. Provisional Application No. 60/290,896, filed May 14, 2001, the subject matter of which is incorporated herein by reference.

### FIELD OF THE INVENTION

This invention relates to data management and more particularly to the implementation of a data management system using a metadata specification.

### BACKGROUND OF THE INVENTION

In data systems design and architecture, well-formed solutions typically provide a distinct separation between business/application logic and the data storage and management. This separation provides a means to encapsulate the information using a software applications programming interface (API) that enforces correct information access consistently across any application that desires to use a data store. Using a data-access API, application developers work with information in a form suitable for the particular information system, independent of the data store access semantics. The interaction with the data store is encapsulated within an object-oriented interface with methods and data structures that are specific to some problem domain.

Designing and implementing a data-access API can be a complex and time-consuming task when the scope of the problem involves a large number of data types and access rules. Development tools provide some relief, wherein they can automate aspects of API development including code generation and metadata-defined framework extensions, wherein the tools provide a skeletal structure for additional development. Most of these tools only work with relational databases as the data store technology, where the developer generates an API using the database table and procedure specifications, and the tool constructs programmatic structures and functions, which encapsulate a generic data-access API. In addition, these data-access APIs are typically constructed using an object-oriented architecture, where the methods and data structure are organized into one or more classes of objects. In many cases, objects are used to represent the intrinsic elements of a database, including: the database, database session, record set, and connection. With these core objects implemented by the development tool, the developer is left to implement the domain specific behavior.

With these types of tools, which include Java data objects and Microsoft's OLE DB Active Template Library (ATL), the developer has great flexibility in creating the specific data-access API required and works well in situations where the data-system is relatively simple and does not have stringent guidelines for working with the data. However, more complex solutions, particularly where the API embodies functional characteristics specific to the problem domain, may require significant custom implementations where the advantages offered by the development tool can become too restrictive. In many cases, developers have opted to develop their own automated code-generation tools to solve the specific requirements of their problem. The reasons to develop a custom solution vary, but often include the development tools being limited to one language or being limited to specific structural forms providing little or no support for behavioral issues.

Other types of tools, provide support by implementing a truly generic data-access API, where almost any type of database access can be accomplish in a language independent means. However, these types of tools, such as Microsoft's Active Data Objects (ADO), make it quick and relatively straightforward to access database records, but they lack any structural or behavioral constraints that enforce a particular type of database access. In this scenario, each application working with the database is responsible for implementing database access restriction code in such a manner as to preserve database integrity.

Other types of development tools try to address these shortcomings by taking a more comprehensive systems-oriented approach, wherein they provide a complete development environment and runtime framework, which alleviates the developer from doing extensive integration or interface development. These system development tools allow developers to create end-to-end solutions taking care of data abstraction, storage, and presentation management. These tools typically generate code that works with some additional software provided by the developer. These systems are very powerful for quickly developing a complete system with a minimum of developer effort. However, these types of solutions often force the developers to adopt system architectures that are not optimal for the particular problem or, worse, limit interoperability with other systems due to proprietary integration interfaces.

With most prior art falling into the types of tools described above, the problem is then how to automate and simplify development of a comprehensive data-access API, which embodies both structural and functional characteristics that can be applied in a language-independent manner. An API and data management system implemented without requiring extensive custom implementation; restrictive proprietary interfaces; or overly simplified interaction models, forcing the application to manage data store integrity issues. There is a need for a development tool that can construct a language-independent data-access API from a logical specification, wherein the system manifests the required behavior and structure without requiring extensive custom implementation by the developer.

In addition, there is a need for this tool to embody not only an API logical specification, but a specification of the data storage schema wherein the tool can use this knowledge to verify and enforce referential integrity and access to a data store. With an integrated approach to API and storage specification, the problem of managing and maintaining synchronization between two separate specifications is eliminated. However, this specification needs to be flexible enough to allow for loose coupling between the API and storage model, such that one does not need to be a direct reflection of the other. This is important for situations where a particular data-access API presents a very limited view of a much larger data store, or in other situations in which multiple APIs are defined for particular types of applications (e.g., administration, system-to-system integration, public access, etc.).

With a solution providing a structured interface model for applications developers, there is an additional need for publication and reflection of the API specification both at development time and run time, wherein the developer and application software can discover the structure of the API using multiple mechanisms. Developers need this capability in order to work with the data-access API without requiring interpretation of the complete logical specification, which may contain highly confidential, or not particularly relevant, information for the developer's current task. Further, the application software may need to query the API during runtime for domain specifications, including type, range of values, etc., such that it can adjust its behavior accordingly.

A development tool providing a data-access API using a logical specification needs to support extensibility of the implementation for situations that cannot be adequately modeled. These extensions need to be supported using a language-independent model, such that the implementation can be done in a language familiar to the developer. In addition, using the logical specification, the data-access API should be easily extensible and adjustable in support of new or changing requirements. Finally, such a tool should also support multiple types of data storage technologies such as relational databases, b-trees, object-oriented databases, etc..

A method and apparatus for implementing a data management system that solves the preceding problems and provides for a greater degree of flexibility and controlled data access would be a useful advance over the prior art.

### SUMMARY OF TERMS

To provide a foundation for the following discussion of the invention it is useful to define certain basic terms.

“API” means Application Programming Interface.

“CASE” means Computer Aided Software Engineering. A CASE system uses computers to assist in the design and development of engineering projects.

“DAC” means Data Access Controller. A DAC is an object that controls access to information in accordance with a metadata storage model and external processing agents.

“DDL” means Data Definition Language. DDL is a computer language used to describe a data structure.

“Meta Model” is a specification of a modeling language by defining model-able constructs, such as data structures, APIs, etc.. Each defined entity can then be used to define a model using constructs defined in the Meta Model. The UML modeling language uses this technique to describe UML.

“OASM” means Object Access and Storage Model. A model that describes an object-oriented access API as well as a storage model. An OASM is constrained by an underlying Meta Model that limits the constructs that can be used to specify a model.

“SOAP” means Simple Object Access Protocol. An XML-based object-oriented RPC protocol.

### SUMMARY OF THE INVENTION

The methods and apparatus of the present invention provide an implementation of a data management system using a metadata specification. In particular, the invention provides for an object-oriented data-access API and a data store from a single OASM, wherein the specification is described using basic canonical forms provided in most object-oriented languages. An OASM model, which can be diagrammatically represented in a CASE tool, is stored in a well-known format such that the methods of the present invention interpret this information, produce a data store schema specification, and generate an object model interface specification. These specifications define the data storage model and application data-access API, and are formatted for use by other development tools and data store systems. Further, the OASM model is manifested by the Data Access Controller (DAC), which provides the implementation for the dataaccess API and controls application access to the data store.

In accordance with the present invention, one or more consumers of data store information interact with the DAC through one or more instances of an object model API, wherein they conduct transactions with the associated data store whose structure is defined by the data storage model generated from the OASM specification. The DAC implements the common functions used in object-model APIs including: attribute accessors, attribute mutators, object creation, object destruction, navigability to other objects (using collection classes), and data store connection management.

In another aspect of the present invention, the object model interface is accessed through views, which provide the means to limit consumer access in accordance with the credentials provided at the time of view creation. Views limit the visibility of certain objects, attributes, relationships, and methods in accordance to the OASM specification, wherein a first consumer possessing credentials has different access rights from a second consumer. Further, each OASM specification may provide for multiple view types, allowing different access to different parts of the OASM interface model.

In yet another aspect of the present invention, the OASM specification can reference externally defined data stores and externally defined object types, wherein the DAC, using custom defined methods, can seamlessly integrate with other information management systems in support of a single object interface model. Using the object interface model defined by the OASM specification, consumers can interact with externally defined data stores or services as well as the OASM data store as a single integrated API. The DAC provides method validation and forwards calls as appropriate to one or more external processing agents to implement the custom method.

References to the remaining portions of the specification, including drawings and claims, will realize other features and advantages of the present invention. Further, various embodiments of the present invention are described in detail below with respect to the accompanying drawings.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

All drawings are depicted using syntax and grammatical structures of the Unified Modeling Language (UML, version 1.1); where appropriate or necessary additional diagrammatic constructs have been used to disclose the nature and preferred embodiment of the present invention.

FIG. 1 is a logical object relationship diagram detailing the functional elements of the present invention and their relationship to one another.

FIG. 2 is a block diagram illustrating one simple deployment configuration of the present invention consisting of two application servers and one database server, acting as a data store.

FIG. 3 is a block diagram illustrating a more complicated deployment configuration of the present invention, where one Data Access Controller (DAC) is implementing two different Object Access and Storage Model (OASM) specifications concurrently. There are two database servers, both acting as data stores.

FIG. 4 is a block diagram illustrating a deployment configuration of the present invention, where custom methods are used to integrate the apparatus with an externally defined database, acting as a data store.

FIG. 5 is a logical object relationship diagram illustrating one possible OASM Meta Model. The Meta Model specifies the object-oriented semantics and constructs used by the present invention.

FIG. 6 is a logical object relationship diagram illustrating one possible OASM specification based on the Meta Model defined in FIG. 5. The diagram defines a simple data storage and object-model interface.

FIG. 7 is a block diagram showing one possible object model interface hierarchy as defined by FIG. 6, where each block represents one object interface.

FIG. 8 shows the contents of the database tables defined by the OASM specification of FIG. 6 and as instantiated in FIG. 7, where the records of each table represent one object in the object interface model. In this figure, a database is being used as the data store.

FIG. 9 is a process flow diagram for initializing and operating the DAC in the present invention.

FIGS. 10A and 10B depict a flowchart diagram showing the general method for creating an object interface specification and data store schema specification from a single OASM specification.

FIG. 11 is a process flow diagram showing how consumers gain access to the object model interface using a view object with a means for authentication.

FIG. 12 is a process flow diagram showing how the attributes of an object (defined in the OASM specification) are accessed or modified.

FIG. 13 is a process flow diagram showing the methods for accessing or modifying associations of a first object with another.

FIG. 14 is a process flow diagram showing the steps for retrieving a collection of related objects from a database data store.

FIG. 15 is a process flow diagram showing the methods for creating an object or destroying an object within the context of a view.

FIG. 16 is a process flow diagram showing the steps for committing changes in a view to a database data store.

FIG. 17 is a process flow diagram showing the steps for executing a custom method as implemented by one or more external processing agents.

FIGS. 18A and 18B show a logical object relationship diagram illustrating the canonical interface and database data store structures for the object construct. The diagrams also show how each object provides a means for discovery of type information.

FIG. 19 is a logical object relationship diagram illustrating the canonical interface and database data store structures for the specialization construct.

FIGS. 20A and 20B show logical object relationship diagrams illustrating the canonical interface and database data store structures for the association construct and its varying forms.

FIG. 21 is a logical object relationship diagram for illustrating the canonical interface and database data store structures for the facade object stereotype.

FIG. 22 is a logical object relationship diagram illustrating the canonical interface and database data store structures for the interface object stereotype.

FIG. 23 is a logical object relationship diagram detailing the functional elements of the Data Access Controller (DAC).

### DETAILED DESCRIPTION OF THE PREFERRED EMBODIMENT

The present invention provides for controlling access to one or more data stores through an object-oriented interface model, where the data store definition and object model are defined by a unified object access and storage model (OASM). A Data Access Controller (DAC) provides an object model interface to access information in accordance with the rules and interface structures as specified by the OASM. Data consumers interact with the OASM specified data store via the object model interface. The DAC validates data consumer transactions, ensures data integrity, and limits access to information, wherein a data store access subsystem is provided such that domain specific logic and structures are the means for interacting with domain data, isolating the consumer from data store integration and implementation considerations.

In the present invention, the OASM is specified using an object-oriented logical model comprising objects and relationships between objects, in accordance to the canonical forms defined by most object Meta Models, namely: specialization, association, ternary association, attributes, methods, stereotypes, etc. The allowable forms are defined by the OASM Meta Model, which is used by the present invention to interpret OASM specifications. Using a CASE tool to provide for diagrammatic representation of objects and relationships between objects, system designers construct an OASM specification that satisfies the requirements of a particular problem domain, and store the specification in a format supported by the embodiment of the present invention.

The present invention uses the OASM specification to generate an object model interface and data store schema, which are realized by the DAC and a data store at runtime. The object interface model is defined in a format readily useable by programming languages during software development. The Interface Definition Language (IDL), commonly used in CORBA and Microsoft COM based software systems, is one example and Simple Object Access Protocol (SOAP) is another. The object interface model is a set of related interfaces and data structures that represents a programmatic contract between the consumer and the implementor of the interface. The DAC implements the interface at runtime, manifesting the specified behavior. The generated data store schema defines a data store structure using the OASM specification and rules provided in the OASM Meta Model. The schema is defined in a format such as Data Definition Language (DDL), in which tables, relationships, constraints, triggers, default values, and other schema related information are specified.

At system runtime, the DAC loads the OASM specification and implements the data access model functions. Consumers of information interact with the DAC and the data store by interacting with objects and collections of objects. From the consumer perspective, the interaction model is essentially the object model as defined by the OASM. The details of marshalling and validating information are managed by the DAC. The DAC implements the basic functions needed for navigating, accessing, and managing the interface objects. Additional custom methods specified by the OASM are implemented by external processing agents, wherein the DAC delegates the custom method processing, using a well-defined application-programming interface (API), to an appropriate processing agent. Each DAC implementation can support any number of external processing agents as provided for in the specific system implementation.

The consumer gains access to an OASM object model using one or more model-defined views, which provide an entry point into the model. With views, consumer access can be controlled according to model attributes such as scope and type of access (e.g., administrative and anonymous access). Views are created and initialized according to consumer credentials, by which the DAC manages access. A view allows consumers to create new objects, gain access to other objects, and commit a set of changes to the data store. Once the consumer has an object, they are able to modify its values and gain access to other objects via the defined relationships within the limits of the access allowed by the view. The view maintains a local cache of retrieved or updated information, providing efficient access to often used data. Once the consumer completes a group of related changes, the changes can be committed to the data store in a single transaction, where the DAC performs a series of data store operations, updating, or inserting new records as needed.

The present invention, thus provides a fully functional, object-oriented, and domain specific data access function over a data store with little or no custom software development. The DAC and data store operate together in accordance to the OASM specification, providing multiple levels of data integrity and access control.

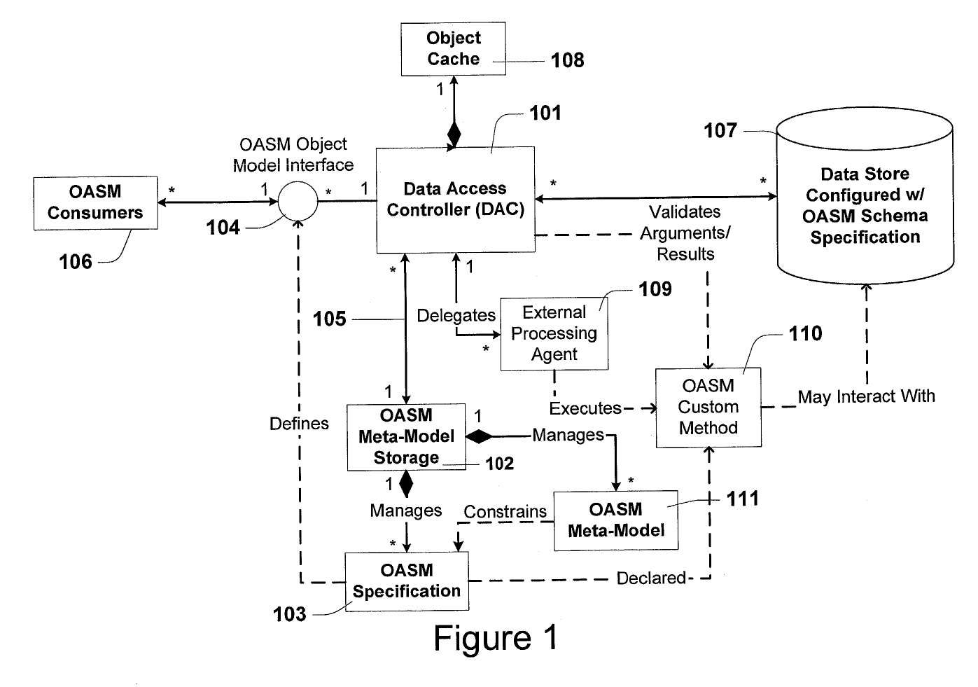

FIG. 1 shows the logical configuration of the DAC, data store, related OASM, and consumers. DAC 101 provides the implementation for many OASM object model interfaces 104, which are defined according to an OASM specification 103. The OASM Meta Model Storage 102 contains zero or more instances of OASM specifications 103, wherein the storage access and management functions are provided to work with OASM data. The OASM Meta Model Storage 102 also contains zero or more OASM Meta-Models 111, which are used to validate the OASM Specifications. Many DACs may interact with the same OASM Meta Model storage 105, which provides for efficient use of memory. OASM consumers 106, which are some software function, interact with the DAC 101 through the interface model 104, wherein multiple consumers can access the same instance of the object model concurrently. The DAC provides for multi-threaded access, while the consumers coordinate the committal of modifications to the database. However, in the preferred embodiment, consumers create multiple instances of the object model 104 as needed to manage multiple concurrent accesses, where the DAC uses transaction features and record locking capabilities of the data store 107. Shared access of a single interface 104 is useful in situations, where multiple consumers access the interface sequentially, with a commit procedure being called often as needed. For each OASM interface model instance, the DAC 101 caches object data in the object cache 108. Each DAC has its own cache, and isolates cached object data per interface 104 instance. The DAC 101 implementation is further supported through the provision of external processing agents 109, which are known to the DAC through some configuration management means. The DAC 104, delegates custom method calls to a particular processing agent 109, which is then responsible for executing the specified OASM custom method 110. The custom method is declared in the OASM 103 by defining the method signature, including method arguments, return value, and processing agent. With custom methods 110, additional functional behavior can be added to the object model, allowing more complex operations than is provided by the core functionality of the DAC. In the present invention, the custom methods include database procedures and local functions, where the methods are able to freely access both cached information in the DAC as well as in the data store 107. The DAC validates calling arguments and return values from custom methods to ensure compliance with the OASM rules.

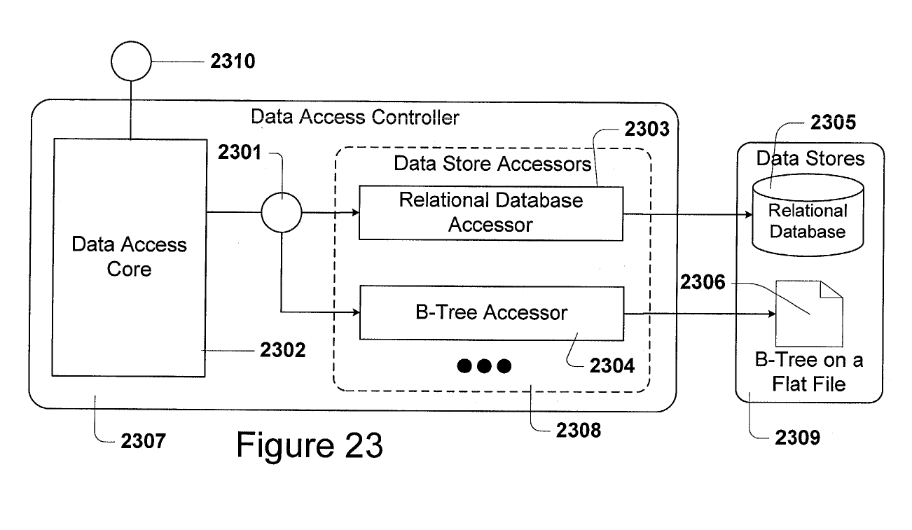

FIG. 23 shows a detail for the DAC 2307. The DAC 2307, as it is used in the present invention, can support multiple types of data storage technologies laS concurrently. Each data storage technology supported in a deployment has a corresponding data store accessor 2308. Examples of data storage technologies and corresponding accessors are a relational database 2305 and relational database accessor 2303, or a b-tree on a file 2306 and b-tree accessor 2304. The Data Access Core 2302 is responsible for handling all object oriented API accesses from the consumer via interface 2310. When the DAC Core receives an access request via 2310, it determines which data storage accessor to use based on the OASM specification and then accesses it via interface 2301. Each data store accessor is responsible for supporting interface 2301 and managing all of the data access nuances associated with the particular data storage technology. Many of the examples presented in this invention description reference a database as a data store to show a specific aspect of the invention. Each of these examples could just as well have used another data storage technology such as a b-tree.

In the preferred embodiment of the present invention, the DAC, and the associated Meta Model storage and object cache are hosted in a manner that optimizes access by multiple consumers, where the network usage and service performance are considered when deploying the invention. The usage patterns for object models are typically highly interactive. Access to information is accomplished through multiple data accesses for any one object; as such, it is typically beneficial to instantiate a DAC on each server using the OASM interface model. In this configuration, network remote procedure calls are minimized. However, multiple server configurations are also supported, where the object interface model can be accessed using any one of the distributed computing architectures, including (but not limited to) RMI, COM+, SOAP, and CORBA. To facilitate an XML-based distributed computing architecture, such as SOAP, this invention has the capability to serialize and de-serialize the data contents of its objects into/from an XML document. A single object, collection of objects, or object tree (or view) can all be serialized/de-serialized into/from an XML document.

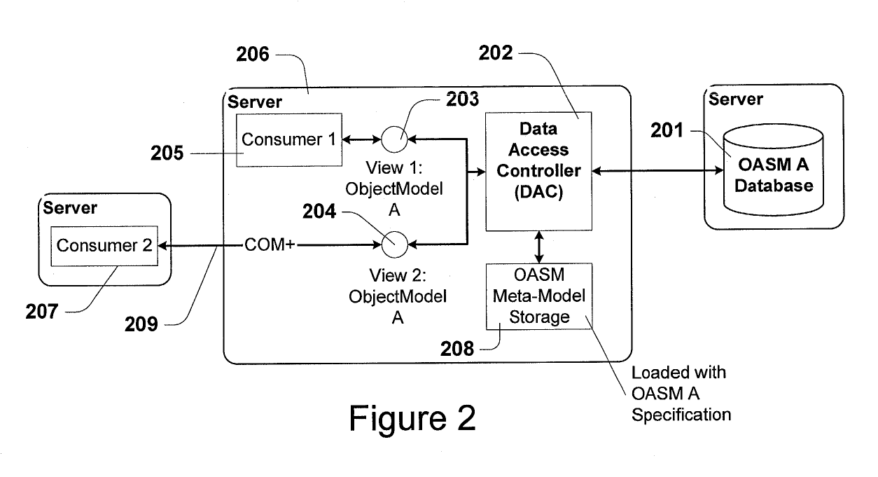

FIG. 2 shows an illustrative example of a simple DAC configuration comprised of two servers and one relational database server (acting as a data store) hosting the OASM database. The relational database 201 has a loaded OASM A schema, which the DAC 202 manages access from a second server 206. The DAC 202 is configured with the corresponding OASM A specification, which is loaded into the Meta Model Storage 208. The Consumer 205 interacts with the OASM A data using the View 203, where the DAC has manifested the Object Model A interface as specified in the OASM A specification. With both the consumer 205 and DAC 202 hosted on the same server 206, the DAC encapsulates the complexities of database and network communications management. Consumer 207 shows a remote server connection to another view 204, again with implementation provided by the DAC 202. In this configuration, consumer 207 interacts with the Object Model 204 in a manner consistent with generalized distributed computing architectures: in this case, consumer 207 uses Microsoft COM+ capabilities to interact 209 with the object model view 204. Though not as efficient as the interaction between consumer 205 and the DAC 202, consumer 207 has the same level of access.

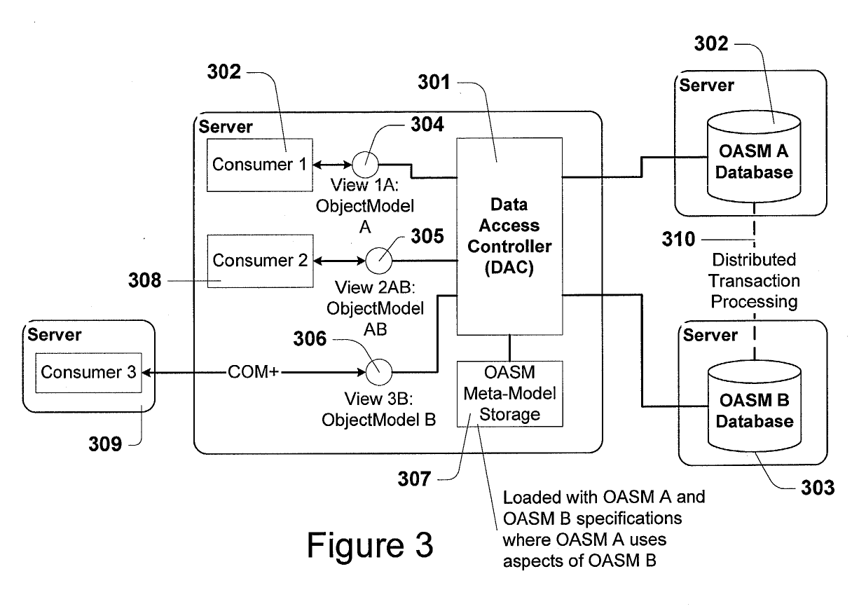

FIG. 3 shows an illustrative example, where a single DAC 301 is hosting two OASM specifications: OASM A and OASM B. In this configuration, two separate database servers (acting as data stores) host the OASM A database 302 and OASM B database 303, where distributed transaction processing capabilities 310 of the database software are utilized to coordinate database operations between the two databases. The DAC 301 is configured with both OASM A and B specifications loaded into the Meta Model storage 307. As such, the DAC can support both ObjectModelA 304 and ObjectModelB 306 concurrently. In this example, some aspects of the OASM A specification is dependent upon the OASM B specification, wherein View2AB 305 provides an aggregate view of both models. Consumer 308 uses view 305 to interact with both OASM A and OASM B data through a single object model interface. The DAC 301 takes care of data integration and management as provided for in the OASM specifications; this benefits consumer 308 by encapsulating the multiple database integration issues. Consumer 308 works with the information without explicit knowledge of the source. Consumers 309 and 302 interact with views 306 and 304 respectively, wherein the views limit the access to just one OASM. Consumer 309 located on a remote server interacts with view 306 using COM+.

By supporting multiple OASM models concurrently, the present invention provides aggregation and integration functionality, which encapsulates the sometimes complicated information management between multiple databases. Further, the OASM specifications can reference and include other OASM specifications, creating a means for packaging data management functions into highly cohesive, well-formed components with minimum coupling. The packaging also provides for a means to deploy different OASM components on different servers, wherein the administrator can configure the system for optimal loading and server performance.

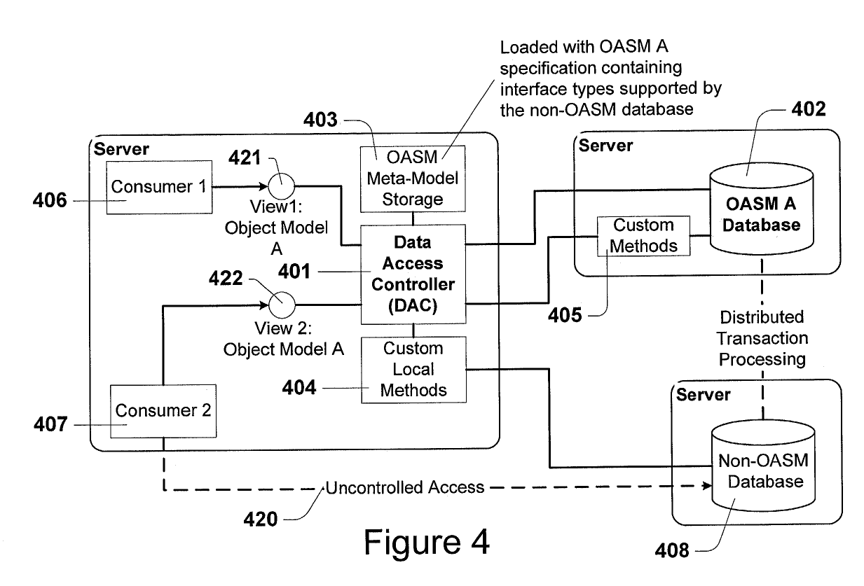

FIG. 4 shows an illustrative example of external database integration, where the DAC 401 can utilize information in a non-OASM database using custom methods.

As in previous examples, the DAC 401, OASM Meta Model Storage 403, and OASM A database 402 (acting as a data store), are loaded and configured according to the OASM A specification, which enables consumers 406 and 407 to access information through object model interfaces 421 and 422. In this configuration, however, the OASM A specification contains declarations of custom methods 404 and 405, which interact with the on-OASM database 408. The custom methods 405 are custom database procedures that interact with both databases 402 and 408, using the distributed transaction processing fuctionality provided by the database software. The DAC uses external processing agents to execute the custom methods. The consumers 406 and 407 can access information contained in the database 408 using the same object model interface as they would use to interact with the OASM A information. The OASM A specification can also specify additional object types specific to the custom methods, which are not defined in the OASM A database 402. The DAC 401 uses these additional object types to manage the information passed between the consumers and custom methods 404 and 405. The DAC ensures that consumers 406 and 407 interact with the information in accordance to the access rules specified by OASM A when using the views 421 and 422. However, consumer 407 performs uncontrolled operations 420 through other means as needed.

In the present invention, custom methods provide the means to implement any domain-specific behavior including integration with other non-OASM data stores. The OASM specification can incorporate additional object type specifications, which can be used by custom methods as needed to package and integrate information. These additional types are managed by the DAC and defined in the object interface model, but not defined in the OASM data store schema definition. The system designer can use these capabilities to integrate multiple data systems under one unified object model interface, greatly simplifying consumer access and improving system data integrity.

The present invention uses a Meta Model to define and constrain the OASM specification information. This Meta Model is similar in some respects to other object oriented language Meta Models such as the UML Meta Model, in order to facilitate compatibility with many of the CASE tools currently available for software development. The Meta Model specifies the type, relationships, and attribution available for use by OASM specifications. The Meta Model information is published prior to design of the OASM specification such that the designer can comply with the rules and constructs. The present invention concurrently supports one or more meta-models, where each OASM specification could have its own associated meta-model. The functional components of the present invention are constructed based on the OASM Meta Model definition, herein OASM specifications complying with the Meta Model can be instantiated and used to control the behavior of the DAC.

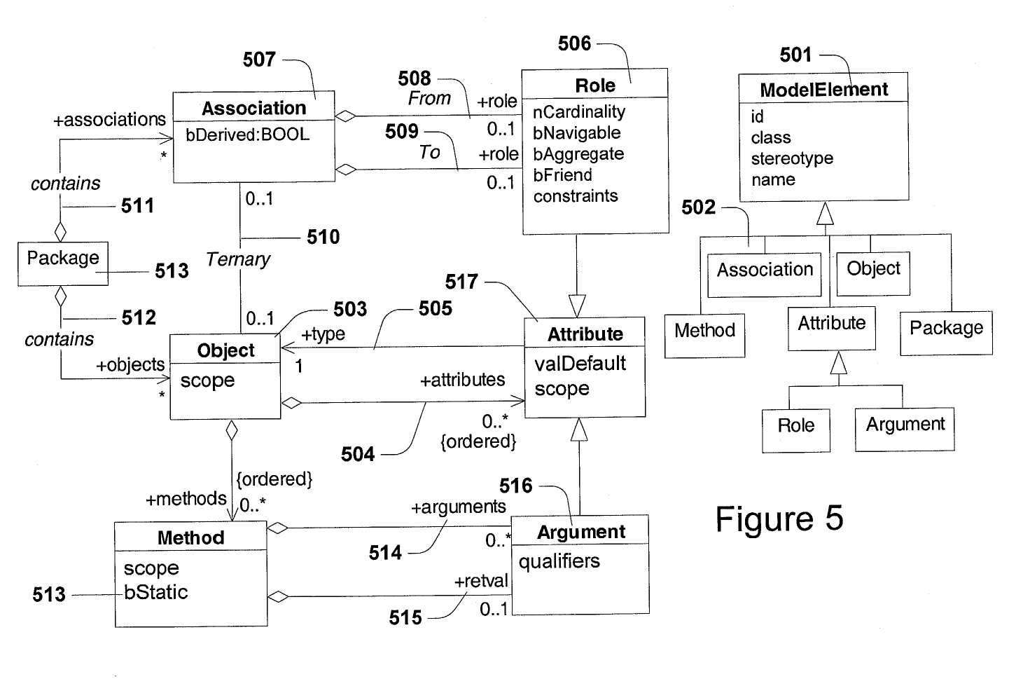

FIG. 5 shows one possible OASM Meta Model. Every object of the Meta Model is a specialization of ModelElement 501, which specifies that every element have an identifier (id), a class type (class), a stereotype, and a name. The identifier is a unique value that ensures the model element is uniquely identifiable with respect to other model elements. In the preferred embodiment of the present invention, identifiers are typically universally unique, such that there is no element ambiguity between multiple related OASM models. The class specifier qualifies the model element as to its specific type; the exact meaning is dependent on the particular specialization. The stereotype is a general type qualifier of the element, which specifies the category or nature of the element. The name specifies a user-friendly name. The ModelElement 502 is specialized by the Association, Attribute, Object, Method, and Package types. These types form the core of the Meta Model specification, where the Object 503, represents the fundamental type specifier. In addition to the attributes provided by the ModelElement, the Object 503 element has a set of zero or more ordered attributes 504 and zero or more ordered methods. The method 513 element defines a functional action and has attributes defining scope and whether the function is an instance or class (static) type function. Class, or static, functions provide global type operations. Each method 513 has zero or more arguments 514 and zero or one return value 515, where each Argument 516 is a specialization of Attribute 517 element with additional attributes for further qualifying argument type information. Attribute 517 provides a means to specify type information as provided by the base class ModelElement 501, as well as attributes for scope and default value. The scope attribute, defined in the Object 503, Attribute 517, and Method 513, define the access scope. In general, the scope can be simply private, protected, or public, but can also be associated with a unique scope identifier that can be used by a view to control user access.

The Association 507 element of FIG. 5 provides the means to define relationships between two Objects 503. The type of association is specified by the Model Element class attribute. Association 507 class types include association, dependency, and specialization. Each Association 507 has two roles 508 and 509, which specify how one Object 503 relates to another. A Role 506 is a specialization of the Attribute 507, with additional specifiers for cardinality, navigability, aggregation, constraints, and friendship. The cardinality specifies the number of objects involved in the association; navigability specifies whether having one object allows navigation or access to another object; aggregation specifies the lifecycle of the object and ownership with respect to the other; and friendship specifies whether or not the associated object is a “friend” of the other object, meaning it has special access if defined. Association 507 may also have a ternary relation 510 with an object, which provides further user-defined attributes for the relationship between two objects.

The Package 513 element provides a means to contain or manage multiple Associations 511 and multiple Objects 512, wherein associations and objects are defined and contained within a package. This Package element provides the means for hierarchical organization of OASM specification data, enabling encapsulation and designers to manage scope and breadth of a particular specification. Elements within one package can reference elements in another.

The Meta Model specified in FIG. 5 provides a flexible structure for defining numerous OASM specifications. To further simplify the creation of a workable specification, the preferred embodiment of the present invention defines core, or “built-n”type information that can be referenced without explicit definition in the OASM. These core types include: atomic data types including integer, long, float, double, string, time, date, etc.; association class types including association, dependency, and specialization; internal and custom methods; public, protected, and private scope; and object stereotypes including interface, model, view, data store, and facade.

The present invention implements an object model interface based on an OASM specification. An object model interface is comprised of object interfaces and collection interfaces that allow consumers to traverse from one object to another as provided by association relationships defined in an OASM specification. The object model interface is a hierarchy of objects beginning with the model object, which provides the means to create specific views of the OASM structure.

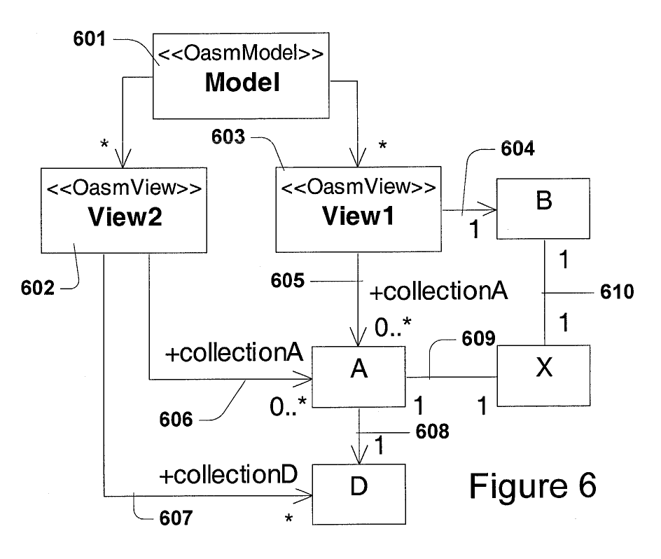

FIG. 6 shows an illustrative example of an OASM specification, which complies with the Meta Model of FIG. 5. The Model object 601 has a stereotype of “OASM Model”, which indicates that it is a type of model and the starting point for consumers needing to access the system. The DAC recognizes the “OASM Model” stereotype and uses the information to denote the principal object model accessor. OASM objects are then accessed via a model object instance. A model object is the starting point for traversing an object model hierarchy. Model objects are typically only static objects in that attributes defined in the model object can be accessed independent of a view object. The Model 601 is associated with multiple view objects 602 and 603. Each view defines different associations with the internal objects of the model. Each view has the stereotype “OASM View”, which has special meaning to the DAC, where built-in methods, security, and caching of internal objects are associated with an instance of either view 602 or 603. View1 object 603 is associated with one B object 604 and zero or more A objects 605 with role name “collection A”. View2 object 602 is associated with zero or more A objects 606, denoted “collection A”, and multiple D objects 607, denoted “collection D”. Object A is also associated with one D object 608 and with one X object 609. Object B 610 is associated with the X object as well. For simplicity, object attributes are not shown, but typically would be defined in an actual OASM specification.

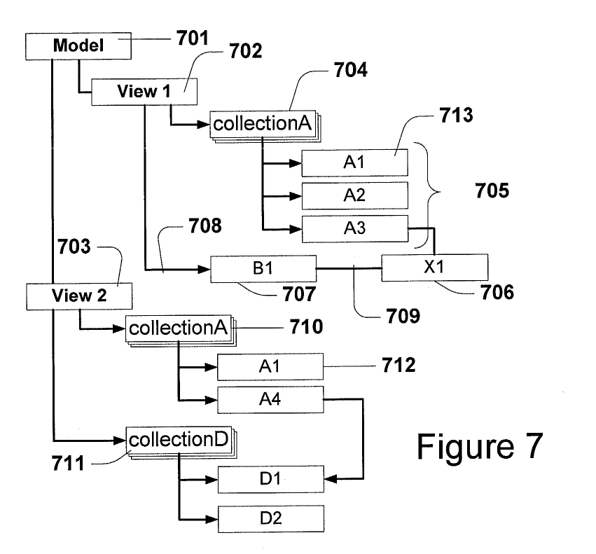

FIG. 7 shows one possible object model interface hierarchy as defined by the OASM specification of FIG. 6. The exact object model interface structure at any one time is dependent upon the consumer's interaction with the object model, where some objects may be added, and others may be removed during any single interaction sequence. Each element of the hierarchy is an instance of the specified object, where the interface implemented by the instance is specified by the OASM specification. The hierarchy begins with the object instance Model 701, which the user creates using some configuration means. With the model 701, the consumer can create multiple views of information contained in the data store; in this case, the consumer has created two view instances 702 and 703. Each view is an isolated accessor to the data store, where object information is managed independently from other views. As specified in the OASM specification, View 702 allows the consumer to access a collection of A objects, which is manifested in the object model using a collection object named “collection A”. The DAC creates custom collection objects, as needed, to support associations with cardinality greater than one. In this case, collection A 704 provides access to multiple instances of object A 705, namely A1, A2, and A3. Object A3 is associated with the object X1 706, which is also associated with B1 707. The arrow on the connecting lines, as represented by 708, indicates navigability, where the consumer may traverse from View1 to B1 but cannot traverse from B1 to View1. If the arrow is not shown, as represented by 709, then navigability is in both directions, where the consumer may traverse from X1 to B1 or from B1 to X1.

FIG. 7 shows a second view 703 with a different hierarchical structure than that of view 702. View2 703 provides access to collections of A and D Objects via collection objects “collection A” 710 and “collection D” 711 as provided in the OASM specification. The object instances A1 712 and A1 713 represent the same data store record in the OASM data store, but are separate instances in the object model since they are in different views. Changes in either 712 or 713 are not changed in the other until the consumer commits the changes in a view, where upon the instance data for the other view can be updated.

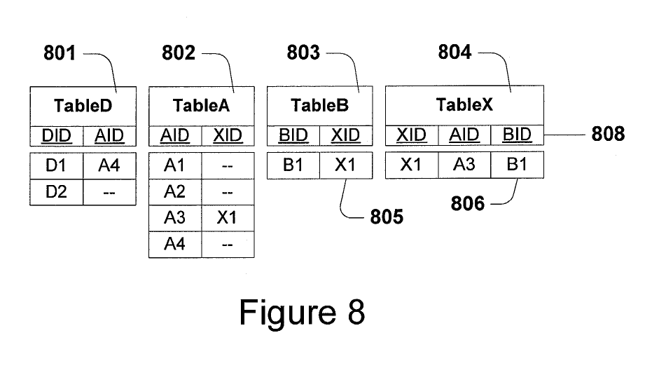

FIG. 8 shows a simplified example that uses a database as a data store, where FIG. 6 defines the database records and table structure, and the data store records in FIG. 7 are used. The database is comprised of four database tables 801, 802, 803, 804, each with a first column defining a unique identifier for a table record and additional columns defining identifiers of related records in other tables. The “- -” symbol indicates a “null” field, which is not currently defined. The columns of each table are labeled as indicated by the underlined text as in 808, where the column name is BID. The records of the database define the particular object model structure, wherein populating the identifiers in one or more records specifies the associations between objects. The relationship between B1 707 and X1 706 of FIG. 7 can be seen in the database tables at 805 and 806; where record B1 of table 803 has a foreign key identifier X1 805 and record X1 of table 804 has a foreign key identifier B1 806. These foreign keys allow the DAC to query information in the table with respect to another record in another table. To retrieve the X1 record, given the B1 record, the DAC could issues a SQL statement such as: “Select * from TableX where TableX.BID=“X1”;” This would return the contents of the X1 record, where the DAC would populate an X object with the resulting information.

The previous example illustrated in FIGS. 6, 7, and 8 shows how the OASM specification can be used to define a database schema and object interface model in accordance with the OASM Meta Model of FIG. 5. These examples are meant to show one embodiment of the aspects of the present invention serving as a specific representation of the concepts discussed in the following sections.

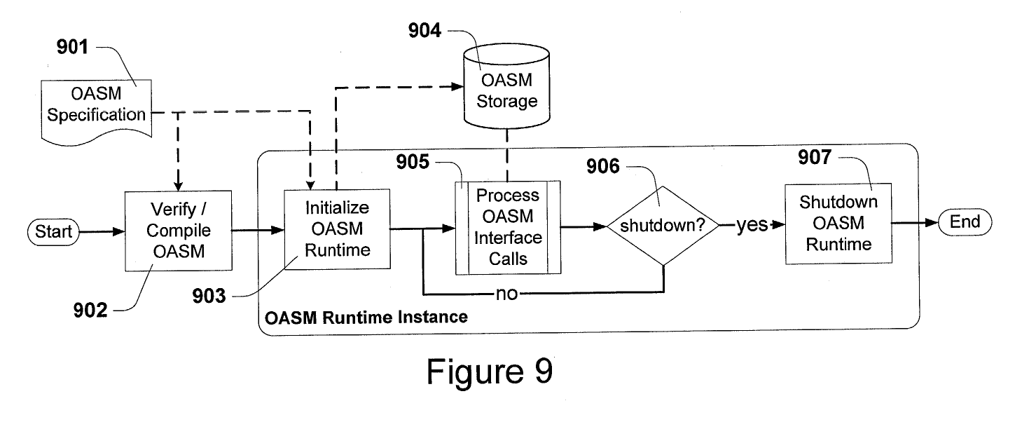

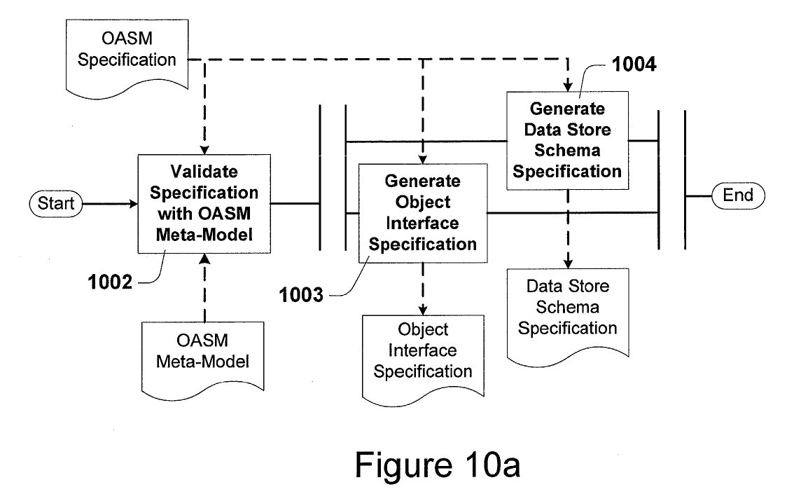

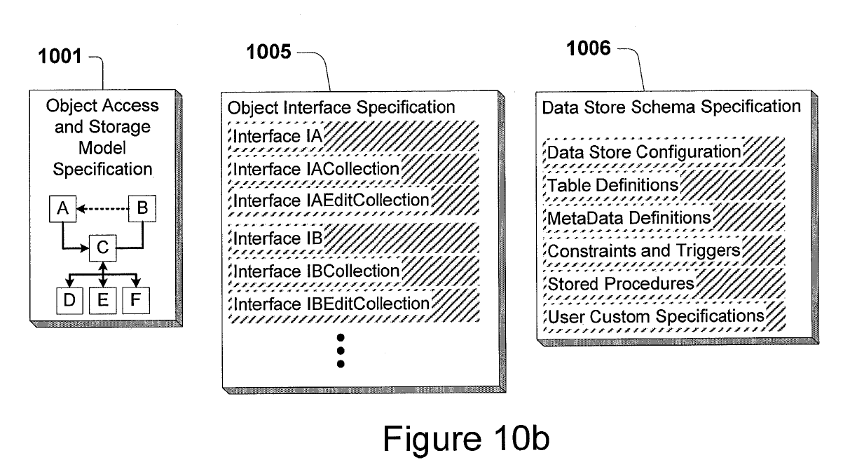

FIG. 9 shows the general processing function of the DAC for each OASM specification loaded into the DAC. The DAC first checks the OASM store 904 to determine if the OASM specification 901 has already been validated and compiled. If the OASM specification 901 has already been loaded into the data store 904, the DAC proceeds to the initialization step, otherwise, the OASM specification 901 is validated, checked for consistency with respect to the specified OASM Meta-Model in 902 and compiled. FIG. 10A shows the details involved in validating and compiling an OASM specification. The DAC then creates an instance of an OASM runtime, which provides the functional behavior for the OASM specification during user processing. This instance is initialized in 903 in preparation for subsequent processing, wherein the OASM store 904 is loaded with the OASM specification (if it hasn't already been loaded) and connections with the data store are verified. Note that part of the initialization process handles creation of the data store. Once initialization is complete, the OASM runtime, within the DAC, processes 905 one or more OASM object model interface calls, interacting with the data store as needed. OASM runtime processing continues until shutdown is indicated 906. OASM Runtime shutdown 907 flushes the local cache and closes any connections with the data store. Any transactions active with the data store are allowed to complete prior to closing the connections. The OASM interface processing 905 is primarily conducted using views, where the consumer begins with an instance of the model object and gains access to a view by supplying appropriate credentials.

To enable integration with existing data stores and software systems, the present invention provides for the generation of interface specifications and data store schema definition using the OASM specification. In the preferred embodiment, both the interface specification and data store definition are provided in an implementation neutral format for the widest possible utility.

FIGS. 10A and 10B show the general method for generating both the interface and data store specifications from the OASM specification. An OASM specification 1001, contained in one or more related files or documents, is validated 1002 with respect to the OASM Meta-Model. In the preferred embodiment of the present invention, the OASM specification is stored in a format that facilitates import and export from CASE tools. Useful formats include XML, Object Constraint Language (OCL), and the Microsoft Repository. Once validated, the OASM specification is used to generate the interface specification 1003 and data store schema 1004. The two specifications can be generated in any order, or concurrently, since there is no strict coupling requirement.

The generation of the object model interface specification 1003 in FIG. 10A involves traversing the OASM specification, generating interface specifications for each object, and defining one or more collection interfaces for instances where collections of a type of object are referenced. The exact structure of the interface specification is dependent upon the target language and representation. When generating IDL, for example, the interface specification can be defined in a similar pattern as shown by 1005, where the object interface is declared first, with subsequent interface declarations for a read-only and editable collection. In addition to specifying attributes and custom methods, the generator defines additional methods for accessing associated objects and other methods depending upon the stereotypes and properties defined within the OASM specification. The interfaces are typically generated in a manner to minimize circular references using forward declarations or careful ordering. In the preferred embodiment, IDL is the primary format for generating interface specifications, with the generator supporting platform variations as needed (COM+, CORBA, RPC, SOAP, etc.) However, generators can be provided for other object-oriented languages as needed.

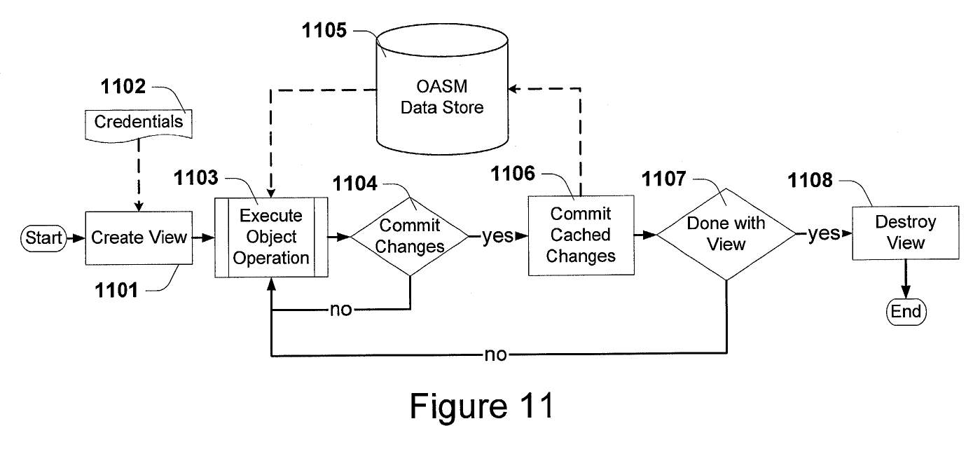

The generation of the data store schema specification 1004 in FIG. 11A is generally comprised as depicted by 1006, but varies depending on the data store technology. A database data store could contain definitions for the following: data store configuration, table definitions, metadata definitions, constraints and triggers, stored procedures, and custom specifications. In the preferred embodiment, the Structured Query Language (SQL) Data Definition Language (DDL) is the preferred schema specification format (baseline version ANSI X3H2-89-151/ISO DBL CAN-3a, or as commonly referred, SQL 2) for databases since most database software supports the standard. However, other formats can be generated if needed. The data store configuration defines the data store configuration parameters. These values are typically data store technology specific, but default values are provided as a starting point. The table definitions are specifications of the objects and association tables, columns, check conditions, and relationships. The metadata definitions provide the data store with information about the structure of the data store, types, and relationships. A set of tables is created to contain information in the OASM specification, which is used by data store procedures or external users to control processing. The constraints and triggers define special behavior as defined by the OASM specification. The stored procedures consist of both custom and generated data store procedures. The generated stored procedures support the DAC runtime functions, as well as provide some administrative capabilities. Multiple object actions and cleanup operations are typical of the generated procedures. Lastly, the data store definition will typically contain additional user definitions, which further extend the data store definition.

In the present invention, the general structure of the interface and data store schema specifications are mostly platform independent and can be characterized through canonical forms with respect to object modeling. These forms are further discussed later on in this document. Some differences will exist depending on the target system and output format of the specification. In the preferred embodiment, these differences are handled by the generators, leaving the OASM specification largely platform independent.

FIG. 11 shows the process for accessing the object model within the context of a view object. With the exception of the model object methods, all other object model accesses require the consumer to create a view. Views provide the DAC a context in which to manage a related set of object model operations. Once the consumer has the model object, they can create views 1101 into the object model as defined in the OASM specification. In certain cases, the consumer may submit special credentials 1102, which are validated by the DAC prior to returning the view object. The use of credentials provides the means to control consumer access to parts of the model as allowed by the OASM specification. View creation may also load specific objects into the cache prior to consumer access. The DAC will call a custom “initialize” method on the view object if defined in the OASM specification. Custom initialization is useful for pre-loading often used, relatively static information, which can substantially improve system performance. Once a view object has been obtained, the consumer can access any objects and object attributes navigable from the specified view by using a series of object operations 1103. The consumer conducts a number of operations, building up changes in the view cache, whereupon they commit the set of changes to the data store 1104 and 1106. In the present invention, changes are made to the OASM data store 1105 in user-controlled batches in order to optimize communication with the data store. This process of changes and committal continues until the consumer is finished with the view 1107. The view is then destroyed 1108, and any remaining cache resources are released. The DAC will call a custom “terminate” method during view destruction, if specified in the OASM model.

One of the most common operations in working with object models is to access or modify attributes of an object. The DAC provides a built-in implementation for this function, coordinating the loading of object attribute data from the data store as needed.

In the preferred embodiment of the present invention, each attribute defined in the OASM specification has additional properties, which provide the means to optimize attribute loading based on expected usage. Attribute information can be loaded at object instantiation or when first accessed.

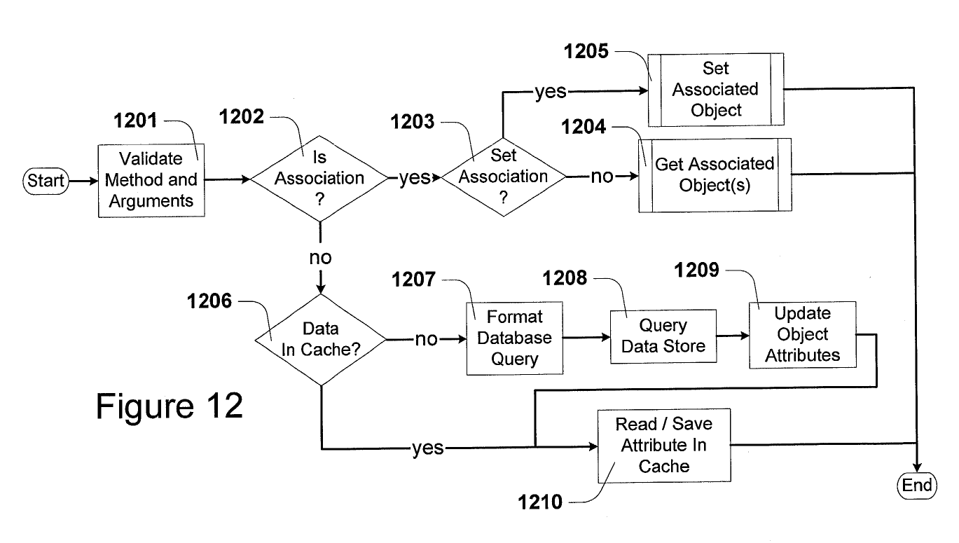

FIG. 12 shows the general process flow for accessing attribute information.

The consumer calls an accessor method on a first object, wherein the DAC validates the method and provided arguments 1201 to ensure cache integrity and access control. The DAC then evaluates whether the method call is for an attribute or object association 1202.

If the method call is for an association, the DAC further evaluates whether the consumer requesting a get or set type of access 1203. In the case of a get, the consumer is requesting one or more objects that are associated with the first object; the DAC processes the request for objects in 1204. In the case of a set, the consumer is associating a second object (provided in the arguments) with the first object; the DAC processes the request by creating an association in 1205. These functions are further discussed later on in this document. If the method call is for an attribute of an object, the DAC further checks to see if the attribute data is in cache 1206. If not, the DAC formats a data store query 1207 using the OASM specification to retrieve information for the attribute. In certain situations, the attribute information for a particular type may not be loaded when the object itself is created. The present invention provides for optimizations such that information is loaded only when needed. The DAC then queries the data store 1208 and processes the results by updating the object attributes 1209 in the local cache. At this point, the DAC either reads or saves the attribute information in the local cache 1210. In the case of a set operation, the attribute information may not need to be loaded from the information first, but this is dependent upon OASM specification. In certain situations the attribute may need to be loaded with other attributes before it can be set. A get operation results in the DAC reading the value in cache 1210 and returns the information to the consumer.

Consumer method calls for associated objects are handled differently than simple attributes, wherein the DAC instantiates new objects and populates them with information from the data store. In the present invention, each object has a unique identifier that is stored in the data store and used by the DAC to index object information in the cache. In the preferred embodiment, the DAC also creates objects representing the association for the purposes of managing association information in cache. For simple associations, these objects are a map between two objects and are used internally. However, in the case of ternary associations, the DAC provides access to association data through methods on the ternary object.

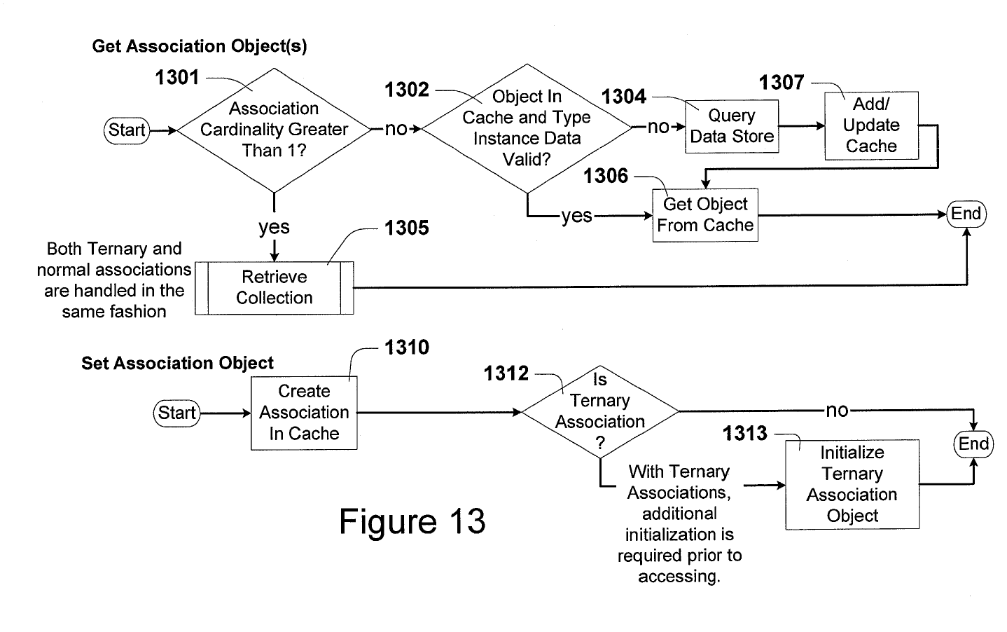

FIG. 13 shows the general methods for retrieving and setting association objects. These methods further define the function blocks 1204 and 1205 of FIG. 12, where the consumer has made a method call on a first object and the DAC has determined that the method relates to associated objects. In the case of retrieving, or “getting” associated objects, the DAC first determines if the cardinality 1301 of the role played by the associated object is greater than 1. If the cardinality is greater than 1, then the DAC uses a typed collection object to return the set of objects associated with the first object. The collection is either created or retrieved in retrieve collection 1305. In association roles with cardinality less than or equal to one, the DAC can return the specific object without first packaging it in a collection. The DAC queries the cache 1302 to determine if the information for the associated object is already in cache. The query checks both that the object is in cache and that the requested attributes for the particular type of object in the association are present. If any information is not present, the DAC will query the data store for the information 1304, and proceeds to add or update the cache information 1307 prior to returning the object to the user. If all information is available in cache, the DAC gets the object from cache 1306 and immediately returns it to the user.

FIG. 13 also shows the procedure for creating, or “setting”, an association between two objects. The DAC creates an association object between the first object and the consumer-provided object. The association information is stored in cache 1310. If the association is a ternary association 1312, the DAC then initializes the ternary object 1313 as well, enabling consumers to access the association information in subsequent calls. In most cases, the consumer provided-object is another object that is managed by the first view of the first object, but this is not a requirement of the present invention. The DAC can associate objects between multiple views or even externally managed objects. When sharing objects between views, the association is owned by the first view and will not be available to the second view until the information is committed to the data store. External object association is facilitated when the external object supports some standardized means of instance identification, and if it is to be stored in the OASM data store, standardized serialization should be supported as well. The DAC manages external objects as defined by the OASM specification, wherein the specification defines external object type, instance identification, and persistence properties.

The DAC coordinates retrieval of objects both from the data store and cache, and packages the resultant set as a collection. For associations with cardinality greater than 1, the collections can be specified as random access or sequential access, wherein the DAC alters its management of collections based on access. In the case of random access, the DAC loads the entire collection of objects into the cache prior to access by the consumer, which provides means to bound and index the objects. The objects are sorted in accordance with the OASM specification, typically on creation date to preserve ordering across all views and instances of the system. Random access is typically used for small collections, where the number of objects is relatively static. In the case of sequential access, the DAC reads the objects in chunks to minimize cache use and to limit expensive data store processing in the case of large collections. The collection object interfaces differ in that the random access interface provides the means to get a specific object in the collection, as well as the count of objects. The sequential interface only provides methods for iterating the collection in the direction specified by the OASM specification.

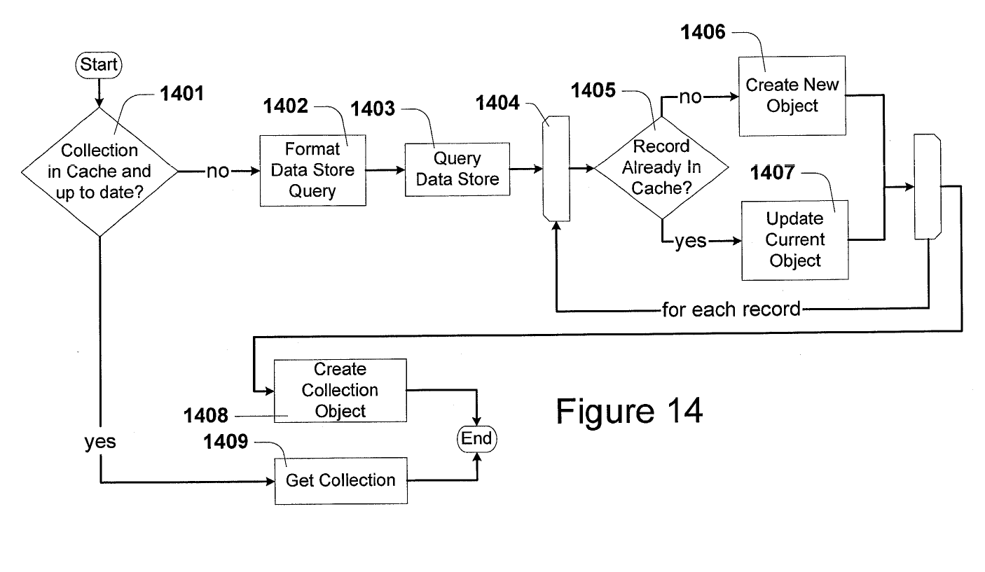

FIG. 14 shows the general method for retrieving a collection of objects. This method further defines the functional block, Retrieve Collection 1305, in FIG. 13. The DAC checks to see if the collection is already defined and up to date in cache 1401; if so, the collection is retrieved 1409 and returned to the consumer. In the preferred embodiment of the present invention, the OASM specification provides an age-of-data property, which is used by the DAC to determine if cached information should be refreshed. This allows the OASM designer to control when information is refreshed. The DAC checks the age-of-data in 1401 and, if it has failed or the collection is not in cache, the DAC then proceeds to retrieve the collection of objects from the data store. The DAC formats the data store query 1402 in accordance with the association specification and then queries for the objects 1403. Upon completion of the data store query, the DAC proceeds to iterate 1404 the record set, populating the cache with new objects 1406 or updating existing objects 1407, if the object already exists 1405. Once all the records have been cached, a collection object (containing all the objects) is created 1408 and returned to the consumer. If the collection is defined as sequential access, only a few components will be loaded at a time and the DAC will iterate 1404 the resultant record set when accessed by the consumer. If the collection is defined as random access, then the record set is iterated all at once, loading all objects into the cache.

The present invention provides for association properties that can further define how collections are queried by the data store. In certain situations, it is useful to filter or sort information prior to loading the information into the object. The preferred embodiment provides for association properties that allow the designer to explicitly define the query for object information. One means for specifying additional association properties is the use of association qualifiers, which can further define specific keys and indexes, used to retrieve associated objects.

In the present invention, the DAC provides functions for managing the lifecycle of an object, including creation and destruction. Using built-in DAC functions, the consumer can create objects and destroy existing objects from the object model. The preferred embodiment provides access to these functions as defined by the OASM specification, where one or more objects in the object model, may support creation of other objects or the destruction of itself. In the present invention, destruction of an object means that the object is removed from the object model and any association objects, contained objects, are removed as well. The destruction or creation of an object by the DAC calls optional “OnCreate” and “OnDestroy” custom methods, which allows the model designer to institute special behavior at the beginning and end of an object's lifecycle. The lifecycle of an object is defined as the time it's created to the time it's marked as hidden or deleted in the data store. The life of an object exists beyond its particular instantiation in some view. The preferred embodiment allows the OASM designer to specify whether an object is deleted or simply hidden. For hidden objects, the DAC filters them out in subsequent queries, such that the information is not loaded in the cache. Hidden objects can be deleted from the data store later, using administrative utility functions provided by the preferred embodiment.

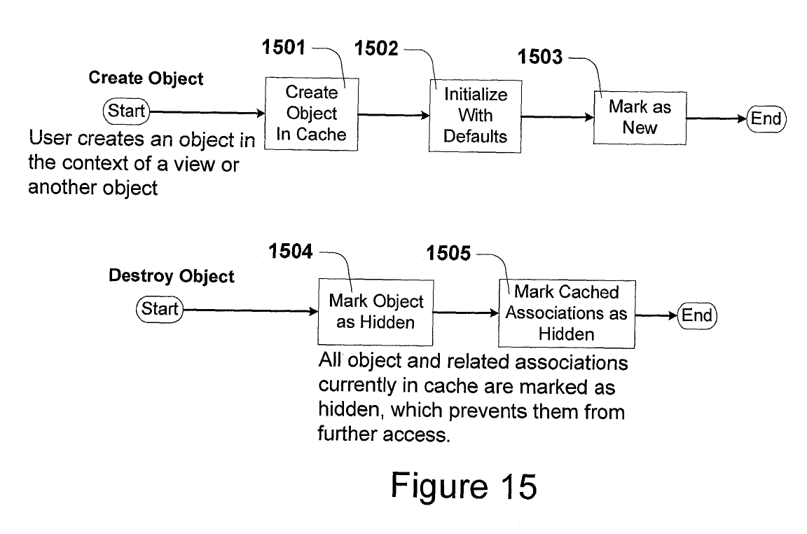

FIG. 15 shows the general methods for creating and destroying an object. If the consumer calls a creation method, either on the view object or a model object, as provided in the OASM specification, the DAC creates an object 1501 of the specified type and initializes it with the default information 1502. The object is then marked as new 1503, such that the new object will be stored in the data store on the next commit operation. The DAC returns the new object and allows the consumer to work with it as needed, modifying attributes and associations as needed. Certain custom methods may require that the new object be stored in the data store prior to execution, in these cases, the custom method call will fail, notifying the consumer of the error condition. For destroying an object, the consumer calls a “Destroy” method on the object, which causes the DAC to mark the object as hidden in cache 1504. The DAC then also traverses the cached associations to the destroyed object, marking them hidden 1505 as well, and if the hidden associations are a ternary association, then the DAC marks associations to the ternary object hidden as well. By hiding the objects, they no longer appear in the object model of an associated view. The data store is not updated with newly created or destroy objects until the next commit method call. This is discussed in the next section.

In the preferred embodiment of the present invention, changes in the object model are accumulated in the view cache until the consumer commits the changes to the data store via a “Commit” method call, whereupon the DAC organizes the changed objects and commits the changes to the data store in a single transaction. Whether adding new objects, removing old objects, modifying attributes, or creating new associations, the commit method updates the data store with all the changes. The consumer can also choose to discard any changed objects, where any changes not previously committed to the data store are essentially thrown away, clearing the cache.

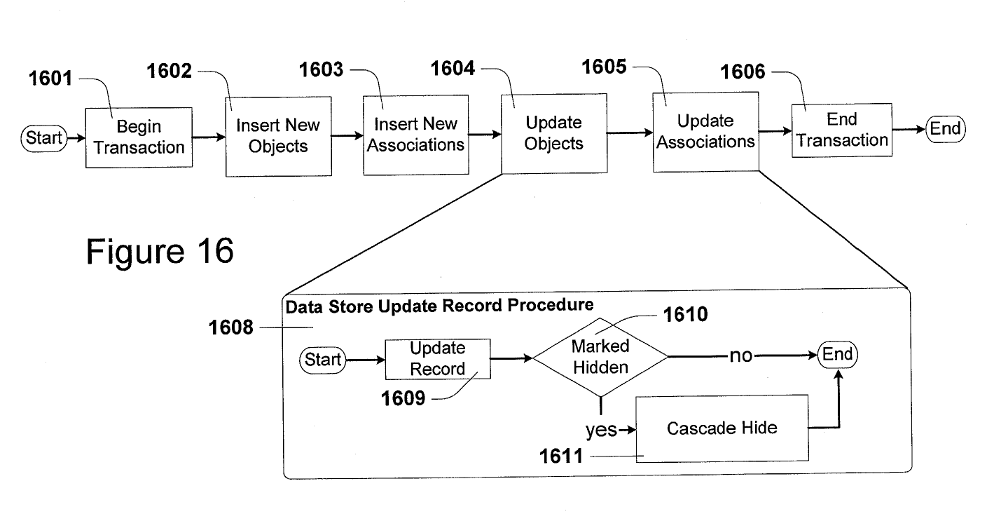

FIG. 16 shows the general procedure for committing object model changes to the data store. The consumer calls the “Commit” method on the view object, wherein the DAC notifies the data store system that a transaction is beginning 1601. The DAC then inserts all new objects 1602 and associations 1603. The object information is inserted prior to association information to preserve referential integrity, wherein the association objects may reference one or more new objects. The DAC then updates object information 1604 and association information 1605 of any changed objects. For changed or destroyed objects, the DAC executes a data store procedure as shown in 1608. First, the information in the record is updated 1609, then if the object is marked as hidden 1610, a data store procedure 1611 is executed to mark any related associations or tertiary objects as hidden as well. After committing changes, the data store transaction 1606 is ended with the data store permanently changing the data store contents. If any part of the committal procedure fails prior to the end of the transaction, the changes can be rolled back without affecting the data store contents.

The preferred embodiment of the present inventions uses one or more external processing agents for the purposes of executing custom methods. The DAC delegates any consumer custom method call to the processing agent defined in the OASM specification for the particular method.

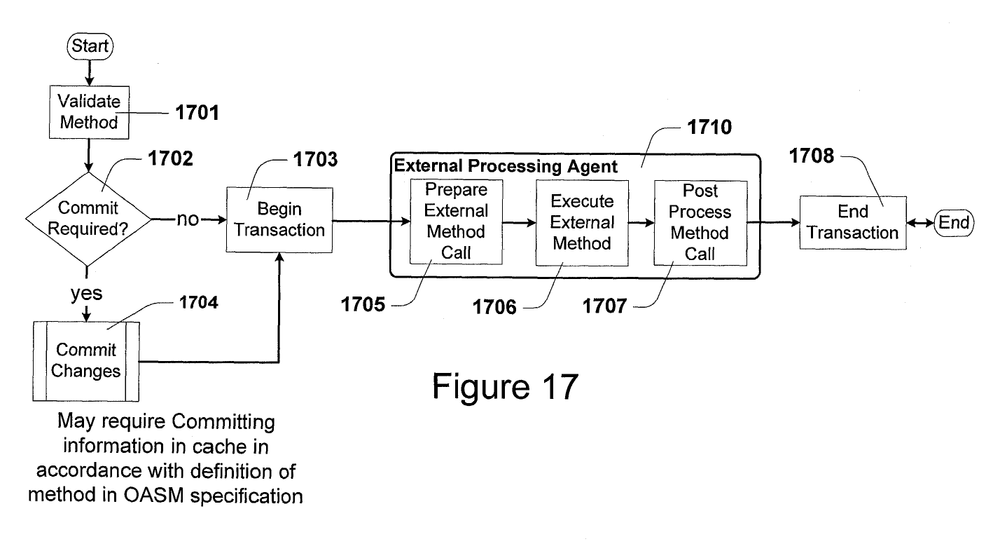

FIG. 17 shows the general procedure for executing a custom procedure. The consumer initiates a custom method call on a first object, the DAC checks to make sure the call is legal and that all arguments are consistent with the definition in the OASM specification 1701. The DAC then commits 1704 any changes to the data store if needed 1702 by OASM specification. The DAC then begins a data store transaction 1703, such that any changes made by the external method can be rolled back should the method call fail. Then the DAC passes the method call and arguments to the external processing agent 1710, which prepares and formats the information in a form appropriate for the external method call 1705. The processing agent then executes the custom method 1706, wherein the results of the operation are returned and postprocessed 1707, such that the results can be managed and validated by the DAC. The DAC ends the data store transaction 1708, once the external processing agent completes the method call, wherein the DAC returns the results of the transaction to the consumer.

In addition to the object manipulation functions specified previously, the DAC also provides functions that allow the consumer to retrieve object type information, perform custom queries of one or more tables, and methods to report on DAC performance statistics. For each object type defined in the OASM, a “GetProperties” method is provided, which allows the consumer to examine the type specification of the object, including attributes and associations with other objects. The DAC custom query method call provides the means to gain access to the object model by querying for a particular set of objects. The custom query methods are typically provided on view objects, but this is not always the case, as the view definition by the OASM specification may hide this function. The preferred embodiment of the present invention allows the built-in DAC methods to be hidden if they are not desired functionality for a particular object type.

The present invention uses canonical forms to define the object interface structure, access rules, and data storage structure. These forms are combined in accordance with the OASM specification, wherein complex models can be developed from simple forms. The present invention defines canonical forms for most of the commonly used object-oriented modeling constructs. However, other forms exist and can be added as needed to support a particular embodiment. With canonical forms for an object, specialization, association, facade and interface stereotypes, the present invention provides suitable means for many different data management problems.

The preferred embodiment of these forms defines object interfaces in IDL, or some preferred programming language, and data store definitions using DDL or other language of choosing. The diagrammatic form conveys the essence of the structures without the sometimes-complicated semantics of a particular software language. For simplicity, all elements shown in the following illustrative figures have public scope. In an actual embodiment, other scope classifications would also be specified, including public, protected, private, etc.

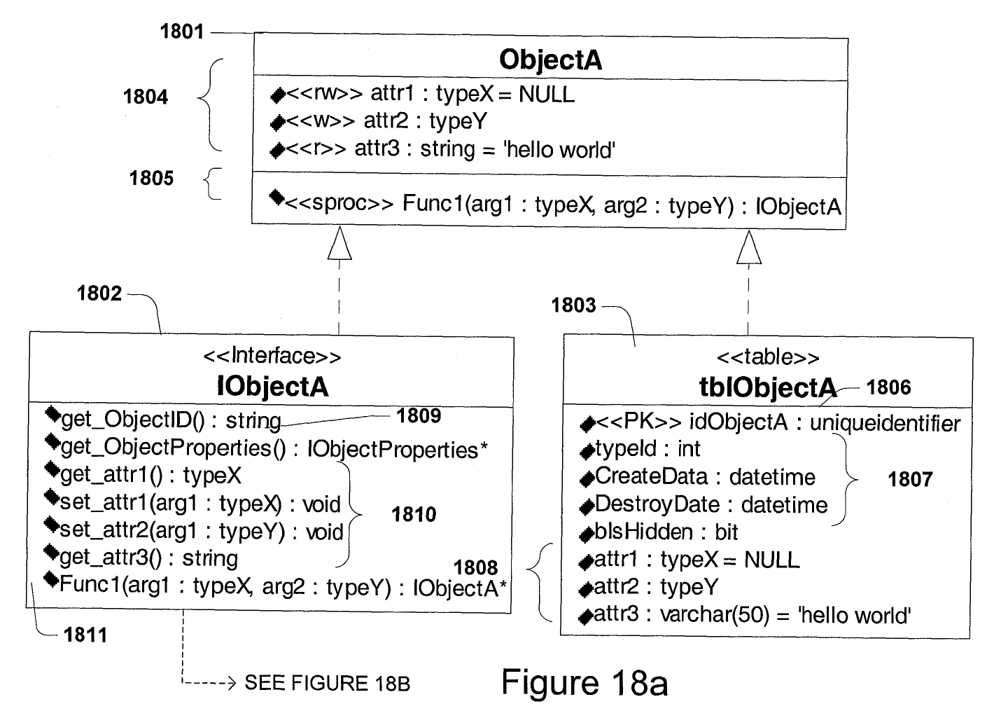

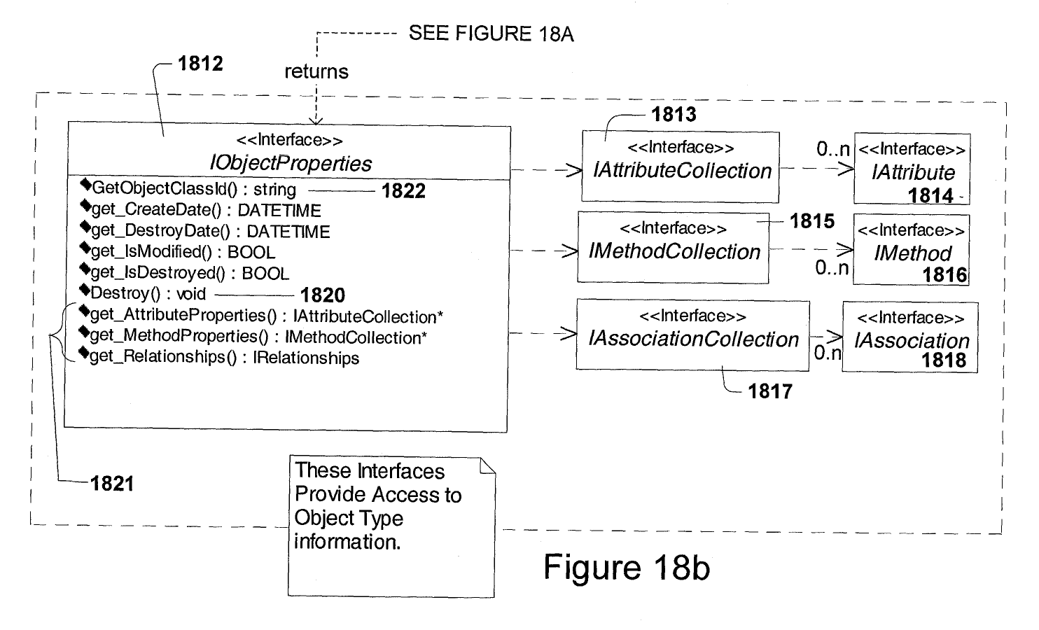

FIGS. 18A and 18B show an illustrative example of the object model interface and database table definition for an OASM Meta Model object. This example uses a database as a data store technology. Given an OASM specification for Object A 1801, comprised of attributes and user-defined methods, the diagrams show how an object interface 1802 and a database table 1803 realize this definition. Three attributes 1804 of Object A show different aspects of suitable type definitions. The first attribute shows a stereotype of “rw”, meaning read and write access, with name “attr1”, data type “typeX”, and default value of “NULL”. The second attribute has stereotype of “w”, meaning write only access, with name “attr2”, data type “typeY”, and no specified default value. If no default value is specified, “NULL” is assumed. The third attribute has stereotype or “r”, meaning read only access, with name “attr3”, data type “string”, and default value “hello world”. Other properties can also be specified for each attribute, including: check constraints, min/max values, textual descriptions, and scope of use. Object A 1801 also defines one custom method 1805, where the function is a stored database procedure as indicated by the stereotype “sproc”. The function 1805, named “Func1”, takes two arguments and returns an interface of type IObjectA. The stereotype denotes the type of custom method, and is interpreted by the DAC at runtime in determining the appropriate external processing agent.

The attributes and method specifications of ObjectA 1801 constitute common forms in defining objects. The present invention generates the interface definition 1802 and database table definition 1803 from the ObjectA specification. The table definition 1803, named tbIObjectA, is comprised of system-defined fields and user defined fields. Fields 1806 and 1807 are system-defined fields. Field 1806 defines a unique identifier for each record, and field 1807 defines the object type, creation date, destruction date, and “hidden” state. The unique identifier provides a unique key for the object that is unambiguous in all situations managed by the DAC. In most cases, this is typically a 16 byte UUID (universally unique identifier) as defined by the Open Software Foundation. The idObjectA field 1806 is also the primary key for the table and is used in relationships with other tables. The object type identifier is also a unique identifier, which uniquely defines the object type with respect to the rest of the model. In cases where the object type is referenced by other models, or externally referenced, the object type can also be defined using an UUID. The CreateDate, DestroyDate, and bIsHidden fields of 1807 are administrative fields used by the DAC and system administrators to manage object data within the database. The fields defined in 1808 are the user-defined attributes as specified in ObjectA 1804.

Continuing the explanation of FIGS. 18A and 18B, the interface declaration 1802 defines the object model interface for ObjectA 1801. Named IObjectA, where the “I” before the name denotes an interface, defines the system accessor methods 1809, attribute accessors, mutators 1810, and custom methods 1811. The system accessor methods 1809 are provided by every object interface, allowing the consumer to get at the object identifier and the object properties. The attribute accessors and mutators, declared in 1810, are defined in accordance to the access specifiers defined by the OASM object specification. In this case, read and write accessible “attr1” has both get and set methods, whereas write only “attr2” and read only “attr3” have only “set” and “get” methods. The custom method specification 1811 defines a language compliant function call with arguments and return type as specified in 1805. The object property accessor, “get_ObjectProperties”, returns an interface object, IObjectProperties 1812. The interface 1812 allows consumers to access system information relating to the class of the object 1822, including: creation date, destroy date, modification status, destruction status; accessors 1821 to attributes, relationships, and method type information. In addition, the object properties interface provides a “Destroy” method 1820, which allows consumers to remove the object from the object model, marking it as hidden and destroyed in the database. The placement of the “Destroy” method can also be incorporated in the primary object interface as defined in the object specification. The accessors 1821 provide the consumers with collections of attributes 1813, methods 1815, and associations 1817, which provide the means to iterate attribute 1814, method 1816, and association 1818 type specifications. The interfaces 1814, 1816, and 1818, expose the OASM specification in a program friendly format.

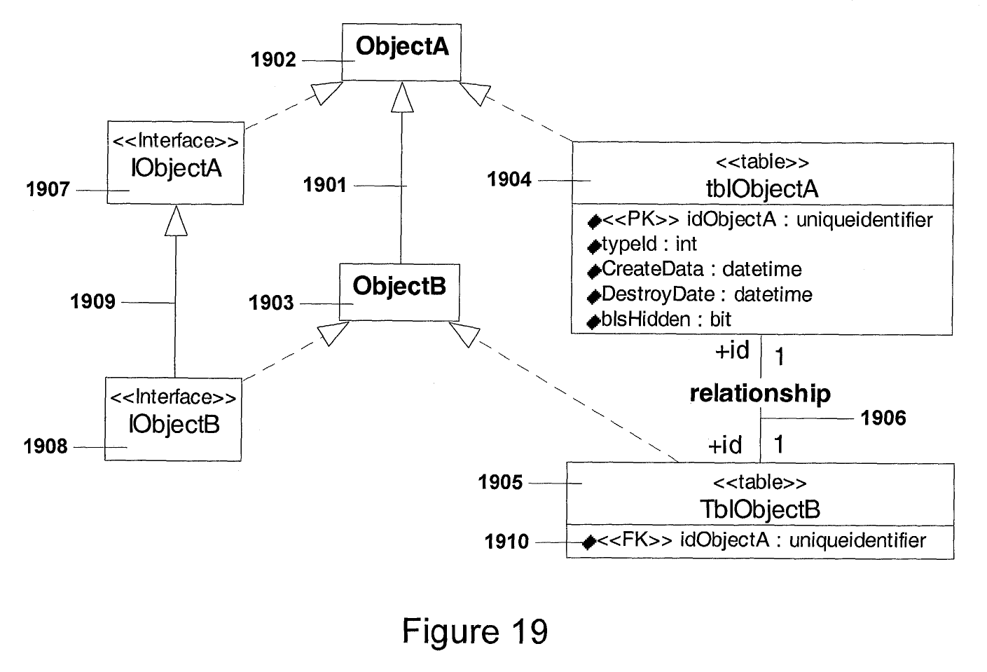

FIG. 19 shows an illustrative example of specialization 1901 between two objects 1902 and 1903. This example uses a database as a data store technology. ObjectA 1902 is realized by database table definition 1904, where the field structure is as defined by the object canonical form previously discussed. ObjectB 1903 is realized by database table definition 1905, where a system field, 1910 defines an object identifier as the primary key. To implement specialization, a foreign key relationship 1906 is defined between table 1904 and table 1905 where the object identifiers, idObjectA 1904 and idObjectA 1905 are constrained to be in a one to one relationship. That means for every record in 1905 there will exist one record in 1904, where the two idObjectA keys are equal. Since 1903 is a specialization of 1902, only the system fields need to be defined in 1904. Object Interfaces 1907 and 1908 define the access methods for objects 1902 and 1903 respectively. The specialization 1901 is implemented as interface specialization 1909, or inheritance as provided by the particular programming language, wherein interface 1908 inherits all the methods of 1907. Other forms for interface specialization are possible including containment and delegation by using an accessor. Interface specialization by containment would involve duplicating the method specifications in 1907 in 1908. Specialization by delegation through an accessor would involve adding a “get_IObjectA” method to the interface 1908, wherein the accessor returns the IObjectA 1907 interface. The present invention supports these forms concurrently, as required by the particular embodiment.

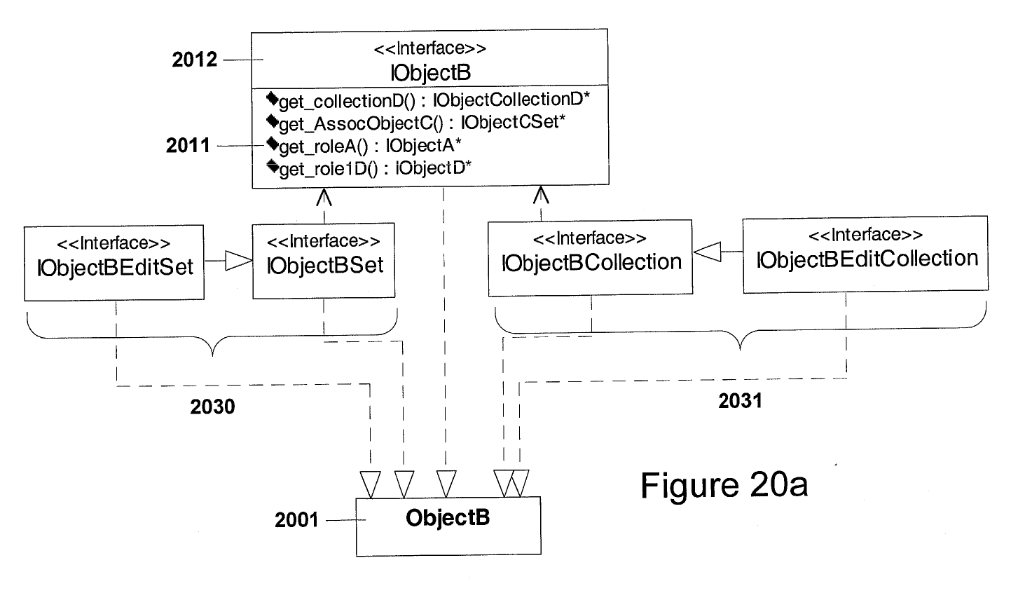

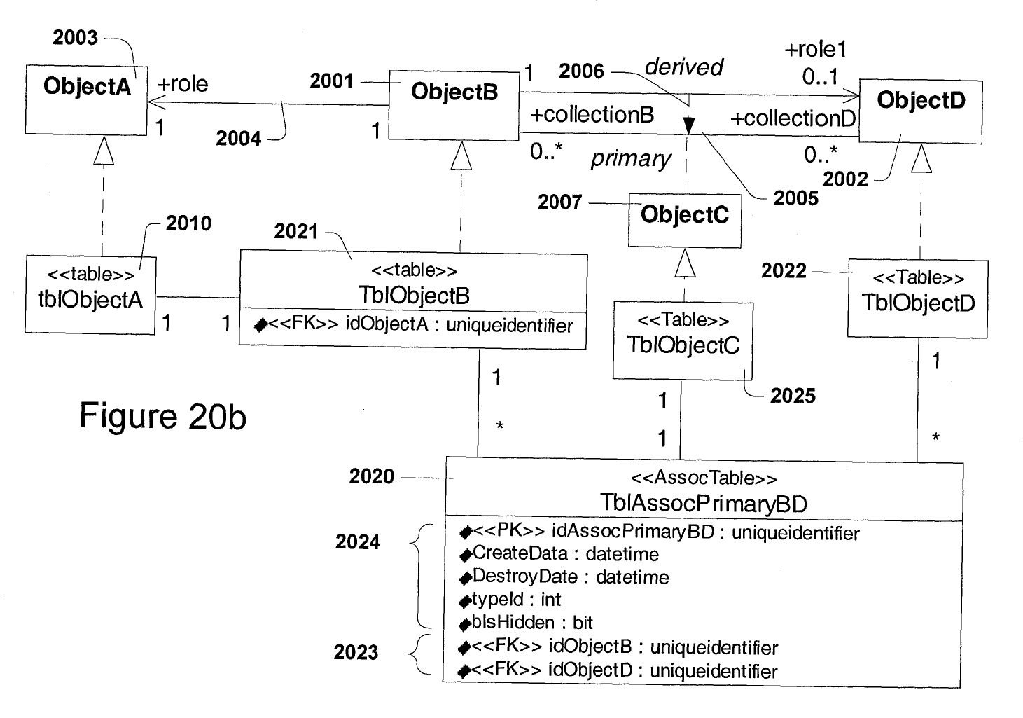

FIGS. 20A and 20B show an illustrative example of associations between two or more objects. This example uses a database as a data store technology. Defining the functional interface and storage structures for associations is perhaps the most difficult form to capture in completeness, given the semantic flexibility to describe such a wide variety of relationships. The associations 2004, 2005 and 2006 exemplify the common aspects of associations in most object oriented analysis. Association 2004 is a unidirectional association between objects 2001 and 2003, where one object 2001 is associated with one object 2003. With one to one type relationships, like 2004, a simplified relationship is possible for situations where the designer needs the most efficiency. A foreign key is added to the table definition of the origin of navigability. In this case, table 2021 has a foreign key identifier, idObjectA, which provides the means to associate an object 2003 with an object 2001. The foreign key is added to the table 2021 since ObjectB 2001 is dependent upon ObjectA 2003 in accordance to the association definition. If the foreign key were added to table 2010, then ObjectA would be dependent upon ObjectB, which violates the model definition. To realize the navigability of association 2004, the accessor 2011 is added to the IObjectB interface 2012, wherein the accessor returns the object 2003 associated with 2001 by the foreign key identifier defined in the table 2021. This method for defining relationships is a limited form, and is useful in certain situations where the association is a relatively simple one. A more general and robust form is shown in association 2005.

Association 2005 in FIGS. 20A and 20B show a tertiary association where objects 2001 and 2002 form a many to many association as specified by the association object 2007. For tertiary associations of the many to many type, and even one to one relationships, an association table 2020 is realized, which contains the association information for each association instance between objects 2001 and 2002. With this approach, the association information is managed independently of the object tables, which is the preferred form in most cases as it allows the association relationships to be changed without affecting the object data. The association table 2020 is related to the object tables 2021 and 2022 using two one to many relationship constraints with the foreign key identifiers 2023. As with tables for objects, association tables also have system fields 2024 for managing the lifecycle of the association. For the tertiary object 2007, an additional table is defined 2025, which is constrained in a one to one relationship with the association table 2020. The table structure of the tertiary object as related to the association object is essentially the specialization pattern discussed previously. To realize the navigability for the association 2005, collections classes for each object, 2001, 2002, and 2003, are defined. The object and collection interfaces for object ObjectB 2001 are shown by 2012, 2030, and 2031, where objects 2002 and 2003 are similarly defined. To navigate association 2005, two accessors are added to the interface IObjectB 2012: “get_collectionD()” and “get_AssocObjectC()”. These two functions allow the consumer, given an instance of IObjectB, to gain access to the set of associated tertiary objects, IObjectCSet, or to the collection associated objects, IObjectCollectionD. Through property settings on the association roles, the designer can choose the navigability, access scope, type of access (read, write, read/write), and type of collection. The collection type can be an ordered collection 2031, or sets of objects 2030. Interfaces 2030 define a set oriented access interface for retrieving objects sequentially using an iterator. Depending on the properties, some set access may be read only or editable, where the editable interface is a specialization of the base interface type. Editable interfaces have a means to add or remove objects from the set. Interfaces 2031 define a random access collection interface, where attached objects can be accessed by passing in some index, similar to sequential access interfaces a specialization is defined for editable collections.

The derived association 2006 in FIG. 20B is similar to the two previous types of associations in terms of interfaces, but differs in that it depends upon the base association for the data storage structures. Association 2006 specifies that it is a derived association of 2005 and that it has unidirectional navigation from object 2001 to 2002. The relationship is a one-to-one relationship where the interface IObjectB 2012 contains an accessor, get_role1D( ), which returns the associated object if not NULL. The derived relationship has properties for limiting the more general relationship. The limiting specification may define sorting and selection based on one or more attributes, including type (or subtype). In the case of association 2006, the filter is defined in such a way that a single object is returned. Derived associations have identical interface semantics to regular associations. The only real difference is that they are dependent upon a base association for data storage structures.

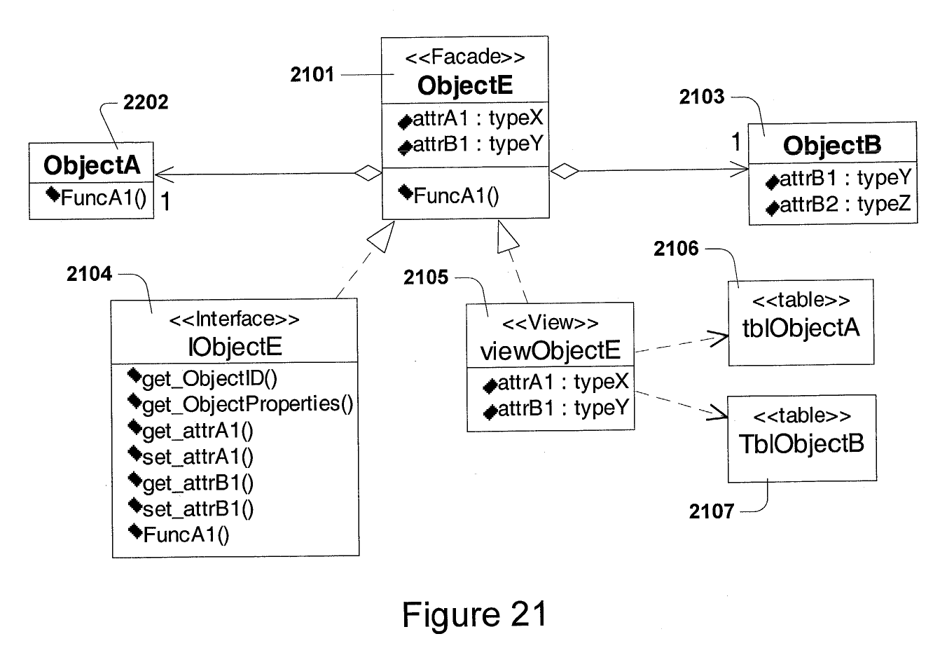

FIG. 21 shows an illustrative example of the “facade” stereotype; where an object 2101 specified with the facade stereotype provides an aggregate view of two or more objects 2102 and 2103. This example uses a database as a data store technology. The facade object 2101 has selected attributes and methods of aggregates 2102 and 2103, providing a combined and simplified set of information. This stereotype is useful for storing information in one format and allowing the consumer to access it in another. The facade object does not realize a table definition, rather it creates a database view 2105 definition, which is a query, that combines the data from tables 2106 and 2107 in accordance with the definition of 2101. The facade object also realizes an interface 2104, where the combined attribute accessors, attribute mutators, and methods are defined.

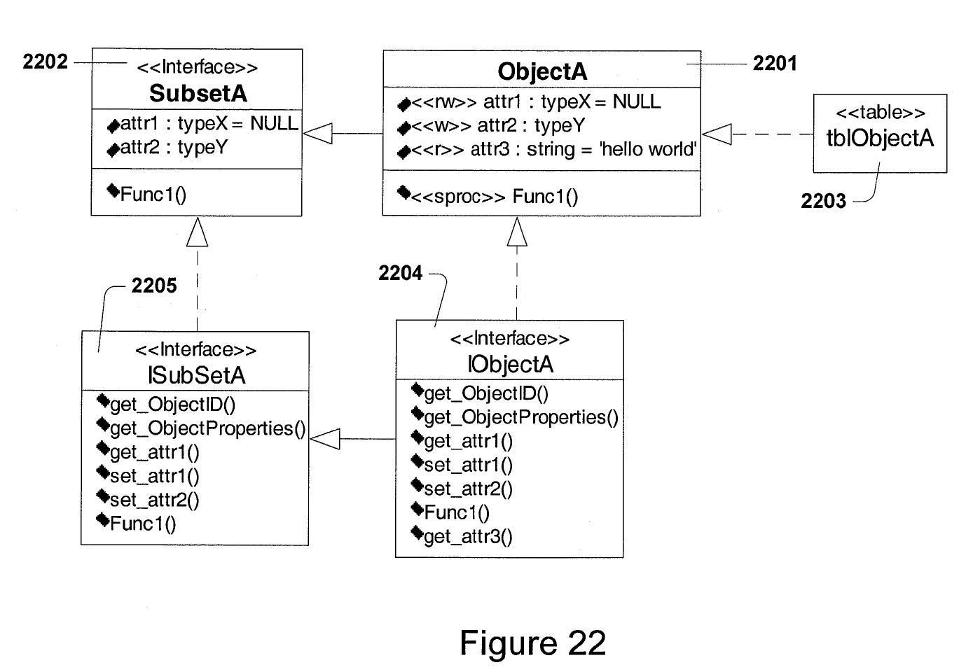

FIG. 22 shows an illustrative example of the interface stereotype 2202 as specialized by 2201. This example uses a database as a data store technology. The use of interface objects 2201 in the OASM specification is similar to base object types of specialization as defined previously, but with one important difference: Objects defined with the interface stereotype do not generate a database table definition. SubsetA 2202 is an interface object, which is specialized by ObjectA 2201. As defined by the previous forms, 2201 has a table definition 2203 and an interface definition 2204. With the interface stereotype, the object 2202 only realizes an interface definition 2205, which is further specialized by 2204, similar to the mechanics of specialization described previously. The interface object 2202 defines a subset of methods and attributes that must be implemented by the specializing object. As is shown, all the attributes and methods of 2202 are defined by 2201, which provides the implementation. The interface stereotype provides a convenient means to limit access to object information as well as support external integration. In certain cases the interface definition 2202 may be defined by an external provider, and implemented by 2201.

Other canonical forms can be defined, as required, to extend the utility of the modeling constructs to other types of problems or in situations, where existing forms do not provide adequate performance. There are some situations where other canonical forms are better suited for the particular problem. Other forms might include parameterized objects, additional stereotypes such as “enumeration” and “domain table”, and specialized processing and storage structures for common object-oriented design patterns. The preferred embodiment of the present invention anticipates that other forms might be useful and thus provides an extension capability, wherein the DAC can be extended to support additional canonical forms through the external processing agent mechanism. These extensions are also applied to the object model interface and data store schema generators.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer system for defining and implementing an object-oriented interface to a data store, the system comprising:
(a) an interface specification component for:
(i) interacting with a user, wherein the user specifies an objectoriented interface to a data store; and
(ii) generating and saving an interface definition file including the object-oriented interface specification as specified by the user, and information describing the data store to be accessed by the object-oriented interface;
(b) a data access component for obtaining the interface definition file and implementing an object-oriented interface to the data store according to the objectoriented interface specification in the interface definition file; and
(c) a data store generation component for processing the interface definition file and creating the data store according to information describing the data store in the interface definition file.

2. The system of claim 1 further comprising a syntax specification file, the syntax specification file specifying an object-oriented syntax in which the object-oriented interface is to be defined.

3. The system of claim 2, wherein the interface specification component generates the interface definition file according to the object-oriented syntax in the syntax specification file.

4. The system of claim 3, wherein the data access component is able to interpret an object-oriented interface specification described according to the objectoriented syntax of the syntax specification file.

5. The system of claim 1, wherein the data access component is distributable across a plurality of networked computing devices.

6. The system of claim 1, where the data access component implements a plurality of object-oriented interfaces simultaneously.

7. The system of claim 3, wherein the data store generation component is able to process an interface definition file described according to the object-oriented syntax of the syntax specification file.

8. The system of claim 1, wherein the information describing the data store in the interface definition file describes an existing data store that the data store generation component will not create.

9. The system of claim 1, wherein the interface definition file includes information describing a plurality of data stores to be accessed by the object-oriented interface.

10. The system of claim 1, wherein the interface specification component is a computer-aided software engineering (CASE) development tool.

11. The system of claim 1, wherein the object-oriented interface specification in the interface definition file includes data objects to be accessed in the data store, and actions which can be performed on the data objects or the data store.

12. The system of claim 11, wherein the interface definition file further includes domain information, such that access to and actions on data objects in the data store may be restricted to members of a particular domain.

13. A system for implementing an object-oriented interface by a data access component according to an object-oriented interface specification, the system comprising:
(a) an interface definition file that includes an object-oriented interface specification and information describing a data store to be accessed by the object-oriented interface; and
(b) a data access component, the data access component operable to:
(i) obtain the interface definition file;
(ii) interpret the object-oriented interface specification in the interface definition file and implement the specified object-oriented interface; and
(iii) generate interface access views through which a user may interact with the object-oriented interface.

14. The system of claim 13, wherein the interface definition file is written in an object-oriented syntax understandable and interpretable by the data access component.

15. The system of claim 13, wherein the interface definition file further includes user view information used by the data access component to generate the interface access views.

16. The system of claim 13, wherein the interface definition file further includes domain information, such that access to and actions on data objects in the data store may be restricted to members of a particular domain.

17. The system of claim 13, wherein the interface definition file includes information describing a plurality of data stores to be accessed by the object-oriented interface.

18. The system of claim 17, wherein the object-oriented interface implemented by the data access component presents the plurality of data stores as one logical data store to a user.

19. The system of claim 17, wherein the plurality of data stores include data stores that are directly manipulable by the data access component.

20. The system of claim 19, wherein the plurality of data stores further include data stores not directly manipulable by the data access component, and wherein the data access component manipulates these data stores through a processing agent capable of manipulating these data stores.

21. The system of claim 13, wherein the data access component is operable to serialize a data object in the data store into data in an extensible mark-up language (XML) file.

22. The system of claim 21, wherein the data access component is operable to deserialize data in an XML file into a data object in the data store.

23. The system of claim 13, wherein the data access component is distributable across a plurality of networked computing devices.

24. The system of claim 13, where the data access component implements a plurality of object-oriented interfaces simultaneously.

25. A method for defining and implementing an object-oriented interface to a data store, comprising:
(a) a user specifying an object-oriented interface to a data store to an interface generation component;
(b) directing the interface specification component to generate and save an interface definition file, the interface definition file including an object-oriented interface specification and information describing the data store to be accessed by the object-oriented interface;
(c) causing a data access component to read the interface definition file and implement an object-oriented interface to the data store according to the objectoriented interface specification in the interface definition file; and
(d) causing a data store generation component to process the interface definition file and create the data store according to information describing the data store in the interface definition file.

26. The method of claim 25 further comprising the interface specification component reading a syntax specification file, the syntax specification file specifying an object-oriented syntax in which the object-oriented interface is to be defined.

27. The method of claim 26, wherein the interface specification component generates the interface definition file according to the object-oriented syntax in the syntax specification file.

28. The method of claim 27, wherein the data access component is able to interpret an object-oriented interface specification described according to the object-oriented syntax of the syntax specification file.

29. The method of claim 25, wherein the data access component is distributable across a plurality of networked computing devices.

30. The method of claim 25, where the data access component implements a plurality of object-oriented interfaces simultaneously.

31. The method of claim 27, wherein the data store generation component is able to process an interface definition file described according to the object-oriented syntax of the syntax specification file.

32. The system of claim 25, wherein the information describing the data store to be accessed in the interface definition file describes an existing data store that the data store generation component will not create.

33. The system of claim 25, wherein the interface definition file includes information describing a plurality of data stores to be accessed by the object-oriented interface.

34. The method of claim 25, wherein the interface specification component is a computer-aided software engineering (CASE) development tool.

35. The method of claim 25, wherein the interface specification in the interface definition file includes data objects to be accessed in the data store, and actions which can be performed on the data objects or the data store.

36. The method of claim 35, wherein the interface definition file further includes domain information, such that access to and actions on data objects in the data store may be restricted to members of a particular domain.

37. A method for implementing an object-oriented interface by a data access component according to an object-oriented interface specification, comprising:
(a) reading an interface definition file that includes an object-oriented interface specification and information describing a data store to be accessed by the object-oriented interface;
(b) interpreting and implementing an object-oriented interface according to the object-oriented interface specification in the interface definition file; and
(c) generating interface access views for a user, through which a user interacts with the object-oriented interface implemented by the data access component.

38. The method of claim 37, wherein the interface definition file is written in an object-oriented syntax understandable and interpretable by the data access component.

39. The method of claim 37, wherein the interface definition file further includes user view information used by the data access component to generate the one or more interface access views.

40. The method of claim 37, wherein the interface definition file further includes domain information, such that access to and actions on data objects in the data store may be restricted to members of a particular domain.

41. The method of claim 37, wherein the interface definition file includes information describing a plurality of data stores to be accessed by the object-oriented interface.

42. The method of claim 41, wherein the object-oriented interface implemented by the data access component presents the plurality of data stores as one logical data store to the user.

43. The method of claim 41, wherein the plurality of data stores includes data stores that are directly manipulable by the data access component.

44. The method of claim 43, wherein the plurality of data stores further includes data stores that are not directly manipulable by the data access component, wherein the data access component manipulates these data stores through a processing agent capable of manipulating these data stores.

45. The method of claim 37, wherein the data access component is operable to serialize a data object in the data store into data in an extensible mark-up language (XML) file.

46. The method of claim 45, wherein the data access component is operable to deserialize data in an XML file into a data object in the data store.

47. The method of claim 37, wherein the data access component is distributable across a plurality of networked computing devices.

48. The method of claim 37, where the data access component implements a plurality of object-oriented interfaces simultaneously.

49. A computer-readable medium having computer-readable instructions capable of performing the method recited in claim 25.

50. A computer-readable medium having computer-readable instructions capable of performing the method recited in claim 37.
